(19) United States
(12) Patent Application Publication
(10) Pub. No.: US 2026/0358486 A1
(43) Pub. Date: Nov. 12, 2026

(54) MITIGATING MOTION-INDUCED MULTIPATH ERRORS IN PHASE-BASED BLUETOOTH RANGING SYSTEMS

(71) Applicants: DENSO International America, Inc., Southfield, MI (US); DENSO CORPORATION, Kariya-City (JP)

(72) Inventors: Kyle Cooper, Plainwell, MI (US); Nima Ghasem, Irvine, CA (US); Eric Smith, Holland, MI (US)

(21) Appl. No.: 19/385,769

(22) Filed: Nov. 11, 2025

Related U.S. Application Data
(60) Provisional application No. 63/802,264, filed on May 8, 2025.

(51) Int. Cl. G01S 11/10

(52) U.S. Cl. CPC G01S 11/10

(57) ABSTRACT

A system and method for enhanced ranging accuracy in phase-based Bluetooth channel sounding systems, particularly in multipath-rich environments such as parking lots. A sensor fusion system may utilize single-antenna setups, incorporating a Kalman filter to mitigate noisy data and multipath effects.

### TECHNICAL FIELD

The present disclosure relates to a system and method for determining a distance between a remote device and an object, such as a vehicle.

### BACKGROUND

Real-time location or position determinations for objects have become increasingly prevalent across a wide spectrum of applications. Real-time locating systems (RTLS) are used and relied on for tracking objects, such as portable or remote devices, in many realms including, for example, automotive, storage, retail, security access for authentication, and security access for authorization.

### SUMMARY OF THE DESCRIPTION

In general, one innovative aspect of the subject matter described herein can be embodied in a method for improving the accuracy of phase-based ranging between two devices in dynamic environments. The two devices may include a transmitting device and a receiving device. The method may include one or more of the following: a) receiving one or more radio frequency (RF) signals at the receiving device from the transmitting device; b) extracting phase and amplitude information from multiple frequency channels of the received one or more RF signals; c) compensating for Doppler shift caused by relative motion between the two devices by adjusting the phase information; d) reducing phase unwrapping errors by increasing a frequency of ranging updates; and e) estimating a range between the transmitting and receiving devices based on phase, amplitude, and Time-of-Flight (ToF) information from the received one or more RF signals.

The foregoing and other embodiments can each optionally include one or more of the following features, alone or in combination. In particular, one embodiment includes all the following features in combination.

In some embodiments, the method may include applying a Kalman filter to smooth phase measurements and reduce effects of noise and rapid phase changes caused by motion.

In some embodiments, phase unwrapping errors may include detecting phase wrapping based on amplitude variations across the multiple frequency channels of the received one or more RF signals.

In some embodiments, compensating for the Doppler shift may include using tone quality information to filter outliers caused by motion and interference.

In some embodiments, the method may include detecting and mitigating multipath interference by comparing phase differences across spatially diverse antennas.

In some embodiments, the method may include detecting amplitude anomalies across spatially diverse antennas by analyzing channel magnitude variations, and correlating the anomalies with phase or time-of-flight inconsistencies to identify and mitigate multipath-affected channels during range estimation.

In some embodiments, the method may include generating channel maps for each antenna path; comparing said maps to identify frequency channels exhibiting fading or constructive interference, and using this comparison to weight or exclude corresponding phase and time-of-flight measurements adversely affected by multipath.

In some embodiments, the ranging updates may be increased by providing a higher channel-sounding rate to minimize the impact of rapid motion between the transmitting and receiving devices.

In some embodiments, the method may include providing frequency diversity with respect to the one or more RF signals by averaging phase measurements across multiple subcarriers to reduce the impact of noise and fading.

In general, one innovative aspect of the subject matter described herein can be embodied in a system for improving phase-based ranging accuracy between a transmitting device and a receiving device. The system may include one or more of the following: a) a plurality of spatially diverse antennas with different polarization configurations at the receiving device; b) a signal processor configured to receive one or more RF signals from the plurality of spatially diverse antennas, extracts phase, amplitude, and time-of-flight data from the one or more RF signals across multiple frequency channels; c) a sensor fusion processor configured to determine a range between the transmitting device and the receiving device based the phase, amplitude, and time-of-flight data; and d) a multipath mitigation processor configured to isolate direct path signals from multipath components based on data from the plurality of spatially diverse antennas.

The foregoing and other embodiments can each optionally include one or more of the following features, alone or in combination. In particular, one embodiment includes all the following features in combination.

In some embodiments, the plurality of spatially diverse antennas may be co-located and configured with orthogonal polarizations to provide signal diversity in multipath-rich environments.

In some embodiments, the sensor fusion processor may include a machine learning system to dynamically weight phase, amplitude, and time-of-flight data.

In some embodiments, the machine learning system may be configured to receive input indicative of a polarization characteristic of each of the plurality of spatially diverse antennas, and to dynamically adjust the weighting of phase, amplitude, and time-of-flight data based on the polarization characteristics to improve ranging accuracy in multipath environments.

In some embodiments, the system may include a Doppler compensation processor that dynamically adjusts phase measurements based on an estimated velocity of the transmitting device.

In some embodiments, the multipath mitigation processor may include a ray tracing model to predict and filter out multipath signals.

In some embodiments, the signal process may include an adaptive filter that adjusts in real-time based on an estimated level of multipath interference and a velocity of the transmitting device.

In some embodiments, the plurality of spatially diverse antennas are configured in a geometric array configured to provide isolation with respect to a direct path signal from reflections in environments with high metal content.

In general, one innovative aspect of the subject matter described herein can be embodied in a method for compensating for Doppler shifts in phase-based ranging systems. The method may include one or more of the following: a) measuring relative motion between a transmitting and receiving device based on Doppler-induced frequency shifts in one or more RF signals received by the receiving device from the transmitting device; b) dynamically adjusting phase measurements across multiple frequency channels to account for the Doppler-induced frequency shifts and to yield Doppler-compensated phase measurements; and c) updating a phase-based range estimation by incorporating Doppler-compensated phase measurements to correct for motion-induced phase distortions caused by the relative motion between the transmitting device and the receiving device.

The foregoing and other embodiments can each optionally include one or more of the following features, alone or in combination. In particular, one embodiment includes all the following features in combination.

In some embodiments, the method may include updating the Doppler-compensated phase measurements based on real-time measurements of velocity and direction of the receiving device.

In some embodiments, dynamically adjusting phase measurements may include incorporating amplitude and time-of-flight data to improve phase measurement accuracy.

In some embodiments, the phase measurements may be adjusted based on environmental factors including as temperature and humidity that affect signal propagation.

In some embodiments, the method may include predicting future Doppler shifts based on historical motion data to preemptively adjust the phase measurements and reduce latency in range estimation.

In some embodiments, dynamically adjusting phase measurements may include adjusting the phase measurements separately for each frequency channel and then aggregating to provide a phase adjustment across the full bandwidth of the system.

Before the embodiments and aspects of the disclosure are explained in detail, it is to be understood that the disclosure is not limited to the details of operation or to the details of construction and the arrangement of the components set forth in the following description or illustrated in the drawings. The disclosure may be implemented in various other embodiments and aspects and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments and aspects. Unless otherwise expressly stated, the use of enumeration should not be construed as limiting one or more embodiments or aspects to any specific order or number of components. Nor should the use of enumeration be construed as excluding from the scope of an embodiment or aspect any additional steps or components that might be combined with or into the enumerated steps or components.

### BRIEF DESCRIPTION OF THE DRAWINGS

FIG. 1 shows a system in accordance with one embodiment of the present disclosure.

FIG. 2 shows a system in accordance with one embodiment.

FIG. 3 shows a device of the system in one embodiment.

FIG. 4 shows a portion of the device of the system in accordance with one embodiment.

FIG. 5 shows the system in accordance with one embodiment.

FIG. 6 shows the system in accordance with one embodiment.

FIG. 7 shows a device of the system in accordance with one embodiment.

FIG. 8 depicts a portion of the system for determining locator according to one embodiment.

FIG. 9 shows a method of operation according to one embodiment.

FIG. 10 shows estimation performance according to one embodiment.

### DESCRIPTION

A system and method for enhancing ranging accuracy in phase-based Bluetooth channel sounding systems, particularly in multipath-rich environments such as parking lots, may be provided. Mitigation for errors introduced by motion and environmental reflections may be achieved, such as by processing one or more of phase, amplitude, and time-of-flight measurements. In one embodiment, a sensor fusion system may be used for single-antenna setups, incorporating a Kalman filter to handle noisy data and multipath effects.

In one embodiment, multiple co-located antennas (e.g., four), each with different polarizations (e.g. circular, linear, vertical, horizontal, diagonal, etc.) may be provided. A multi-polarization sensor fusion system may be provided to further enhance ranging accuracy. The system may leverage one or more of phase unwrapping, amplitude-based range estimation, and time-of-flight data for each polarization, integrating these measurements using a filter, such as a weighted Kalman filter. This system may enhance resilience against multipath interference by combining the unique characteristics of each polarization. Additionally, or alternatively, the use of a weighted combination of estimates across the antennas may facilitate a more robust and accurate final range estimation.

A system and method according to one embodiment may be useful for ranging in complex environments with high signal reflections and interference, and may offer a significant enhancement in accuracy for ranging systems deployed near large metallic objects, such as vehicles. The system and method may prioritize both accuracy and computational efficiency in dynamic and reflective environments.

### I. System Overview

A system and method for determining location information of a remote device relative to an object is provided. The system and method may determine a location of the remote device based on first communications between a first object device (e.g., a sensor [also described as an anchor]) and the remote device. As described herein, the location may be determined based on a plurality of modalities determined with respect to communications between the first object device and the remote device. The modalities may include signal strength, phase-based ranging, and time-of-flight—but are not so limited and may include any combination of characteristics determined with respect to communications between the first object device and the remote device. It is further noted that one modality may be determined with respect to one communication and another modality may be determined with respect to another communication.

For purposes of a phase-based ranging modality, a clock difference may be determined between a first device and a second device, and the clock difference may form the basis for a phase-based range determination for the first communications. The phase-based range may be based on a signal characteristic of communication determined with respect to the first communications, such as a determined phase rotation of the first communications between the remote device and the first object device. Examples of phase-based ranging techniques and modalities is described in U.S. application Ser. No. 18/619,380, entitled SYSTEM AND METHOD FOR RANGING WITH CHANNEL SOUNDING, to Golsch et al., filed Mar. 28, 2024—the disclosure of which is hereby incorporated by reference in its entirety.

The object in one embodiment may be mobile, such that its environment may change depending on the location of the object. For instance, in the case of the object being a vehicle, the vehicle may be stored in an enclosed garage with a movable barrier at night, and then driven to and parked in an open-air parking lot, with one or more other vehicles in proximity thereto. The environmental configuration of these locations can vary in significant ways relative to RF or wireless communications, and the environmental configuration may vary in time even when the object is not moving relative to the environment. Such changes in the environment, as well as possible additional factors, may affect a clock difference between the first device on the second device relative to wireless communications. Additional examples of a system with adapting for environmental conditions is described in U.S. Pat. No. 10,869,161, entitled SYSTEM AND METHOD OF DETERMINING REAL-TIME LOCATION, issued Dec. 15, 2020, to Smith.

In one embodiment, a locator may be provided to determine the location information about the remote device relative to the object based on information obtained from a plurality of ranging modalities.

A locator processor 310, as depicted in FIG. 4, may include a core function 312 operable in conjunction with one or more parameters 314 to determine the location information based on one or more inputs 316, such as at least one signal characteristic of wireless communications, and to generate one or more outputs 318 indicative of a location of the remote device 20 relative to the object 10. The values of the one or more parameters may be selected to yield location information for the remote device relative to the object with a degree of confidence for a given environment. For instance, the locator processor 310 may be configured to determine the location of the remote device relative to the object in an open-air parking lot with no vehicles in proximity thereto or within 4 inches with a degree of confidence of 90% or better. In one embodiment, selecting the values of the one or more parameters may be based on empirical analysis, including obtaining truth data pertaining to an actual location of the remote device relative to the object along with, for each actual location, at least one sample of at least one signal characteristic. As discussed herein, the system may include a plurality of object devices disposed at different locations on the object, such that a plurality of signal characteristics of the wireless communications can be obtained with respect to different positions on the object. The plurality of signal characteristics may be correlated with truth data pertaining to an actual location of the remote device relative to the object, and one or more parameters in conjunction with the core function may be trained or selected to yield location information that approximates the truth data within a degree of confidence.

The locator processor 310 may be configured as one of the plurality of modalities used as a basis for generating a location estimate according to one embodiment of the present disclosure. In this way, the system may include multiple location processors 310, each configured according to one or more modalities for providing an output indicative of a location of the remote device 20 relative to the object 10. Example locator processors 310 for various modalities include a phase processor, an amplitude processor, and a time-of-flight processor, which may be operable to generate respectively phase-based ranging output, amplitude-based ranging output, and time-of-flight based ranging output based on one or more RF signals transmitted across one more frequency channels. The plurality of locator processors 310 may be co-located within the processor 51 or another processor of a device according to one embodiment (e.g., an object device 50 or sensor 40, either of which are also referred to as an anchor device in one or more embodiments)—e.g., the plurality locator processors 310 for the plurality of modalities may be analyzed by a signal processor of the device (e.g., a component of the processor 51 of the controller 58 described herein).

Additionally, one or more locator processors 310 described herein may be configured to receive as an input 316 output from one or more other locator processors 310 and to generate an output 318 based on these one or more outputs of the other one or more locator processors 310. For instance, a locator processor 310 in one embodiment may be a fusion processor operable to obtain, as input 316, output from one more upstream locator processors 310 and to generate an output 318 indicative of a location of the remote device 20 relative to the object 10.

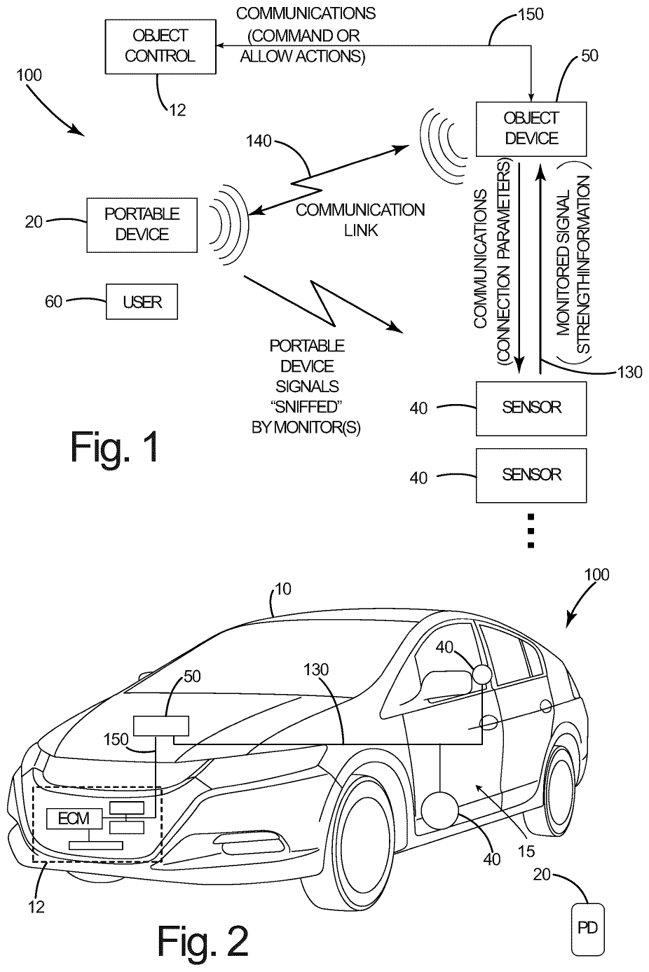

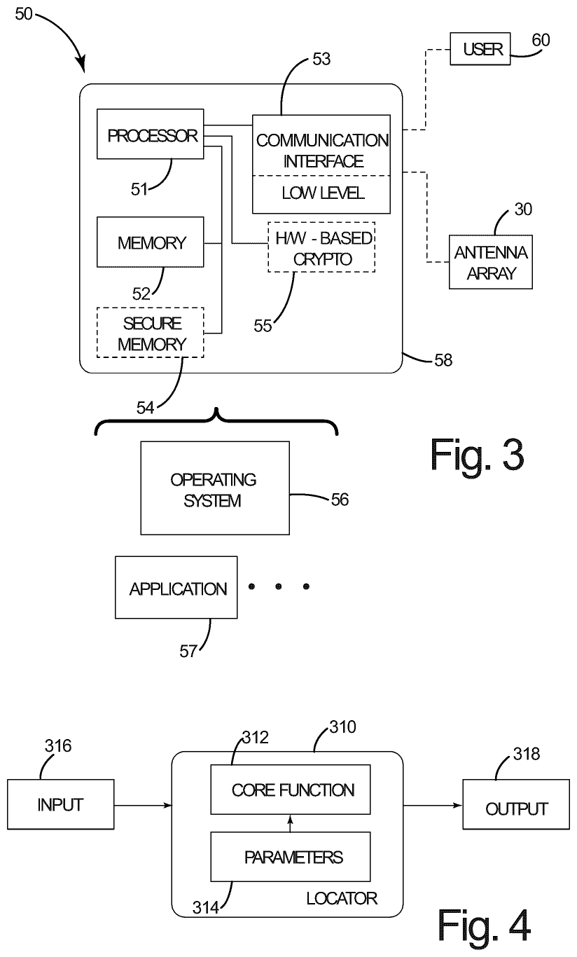

A system in accordance with one embodiment is shown in the illustrated embodiment of FIGS. 1, 2, and 5 and generally designated 100. The system 100 may include one or more system components as outlined herein. A system component may be a user 60 or an electronic system component, which may be the remote device 20, a sensor 40, or an object device 50, or a component including one or more aspects of these devices. The underlying components of the object device 50, as discussed herein, may be configured to operate in conjunction with any one or more of these devices. In this sense, in one embodiment, there may be several aspects or features common among the remote device 20, the sensor 40, and the object device 50. The features described in connection with the object device 50 depicted in FIG. 3 may be incorporated into the remote device 20 or the sensor 40, or both. In one embodiment, the object device 50 may form an equipment component disposed on an object 10, such as a vehicle or a building. The object device 50 may be communicatively coupled to one or more systems of the object 10 to control operation of the object 10, to transmit information to the one or more systems of the object 10, or to receive information from the one or more systems of the object 10, or a combination thereof. For instance, the object 10 may include an object controller 12 configured to control operation of the object 10. The object 10 may include one or more communication networks, wired or wireless, that facilitate communication between the object controller 12 and the object device 50. The communication network for facilitating communications between the object device 50 and the object controller 12 is designated 150 in the illustrated embodiment of FIG. 2 and provided as a CAN bus; however, it is to be understood that the communication network is not so limited. The communication network may be any type of network, including a wired or wireless network, or a combination of two or more types of networks.

In the illustrated embodiment of FIG. 3, the object device 50 may include a control system or controller 58 configured to control operation of the object device 50 in accordance with the one or more functions and algorithms discussed herein, or aspects thereof. The system components, such as the remote device 20 or the sensor 40, or both, may similarly include a controller 58.

The controller 58 may include electrical circuitry and components to carry out the functions and algorithms described herein. Generally speaking, the controller 58 may include one or more microcontrollers, microprocessors, and/or other programmable electronics that are programmed to carry out the functions described herein. The controller 58 may additionally or alternatively include other electronic components that are programmed to carry out the functions described herein, or that support the microcontrollers, microprocessors, and/or other electronics. The other electronic components include, but are not limited to, one or more field programmable gate arrays, systems on a chip, volatile or nonvolatile memory, discrete circuitry, integrated circuits, application specific integrated circuits (ASICs) and/or other hardware, software, or firmware. Such components can be physically configured in any suitable manner, such as by mounting them to one or more circuit boards, or arranging them in other manners, whether combined into a single unit or distributed across multiple units. Such components may be physically distributed in different positions in the object device 50, or they may reside in a common location within the object device 50. When physically distributed, the components may communicate using any suitable serial or parallel communication protocol, such as, but not limited to, CAN, LIN, Vehicle Area Network (VAN), FireWire, I2C, RS-232, RS-485, and Universal Serial Bus (USB).

As described herein, the terms locator, module, model, and generator designate parts of the controller 58. For instance, a model or locator in one embodiment is described as having one or more core functions and one or more parameters that affect output of the one or more core functions. Aspects of the model or locator may be stored in memory of the controller 58, and may also form part of the controller configuration such that the model is part of the controller 58 that is configured to operate to receive and translate one or more inputs and to output one or more outputs. Likewise, a module may be part of the controller 58 such that the controller 58 is configured to receive an input described in conjunction with a module and provide an output corresponding to an algorithm associated with the module.

The controller 58 of the object device 50 in the illustrated embodiment of FIG. 3 may include one or more processors 51 that execute one or more applications 57 (software and/or includes firmware), one or more memory units 52 (e.g., RAM and/or ROM), and one or more communication interfaces 53, amongst other electronic hardware. The object device 50 may or may not have an operating system 56 that controls access to lower-level devices/electronics via a communication interface 53. The object device 50 may or may not have hardware-based cryptography units 55—in their absence, cryptographic functions may be performed in software. The object device 50 may or may not have (or have access to) secure memory units 54 (e.g., a secure element or a hardware security module (HSM)). Optional components and communication paths are shown in phantom lines in the illustrated embodiment.

The controller 58 in the illustrated embodiment of FIG. 3 is not dependent upon the presence of a secure memory unit 54 in any component. In the optional absence of a secure memory unit 54, data that may otherwise be stored in the secure memory unit 54 (e.g., private and/or secret keys) may be encrypted at rest. Both software-based and hardware-based mitigations may be utilized to substantially prevent access to such data, as well as substantially prevent or detect, or both, overall system component compromise. Examples of such mitigation features include implementing physical obstructions or shields, disabling JTAG and other ports, hardening software interfaces to eliminate attack vectors, using trusted execution environments (e.g., hardware or software, or both), and detecting operating system root access or compromise.

For purposes of disclosure, being secure is generally considered as being confidential (encrypted), authenticated, and integrity-verified. It should be understood, however, that the present disclosure is not so limited, and that the term “secure” may be a subset of these aspects or may include additional aspects related to data security.

The communication interface 53 may be any type of communication link, including any of the types of communication links described herein, including wired or wireless. The communication interface 53 may facilitate external or internal, or both, communications. For instance, the communication interface 53 may be coupled to or incorporate the antenna array 30. The antenna array 30 may include one or more antennas configured to facilitate wireless communications, including Bluetooth Low Energy (BTLE) communications and/or Ultra-wideband communications.

As another example, the communication interface 53 may provide a wireless communication link with another system component in the form of the remote device 20, such as wireless communications according to the Wi-Fi standard. In another example, the communication interface 53 may be configured to communicate with an object controller 12 of a vehicle (e.g., a vehicle component) via a wired link such as a CAN-based wired network that facilitates communication between a plurality of devices. The communication interface 53 in one embodiment may include a display and/or input interface for communicating information to and/or receiving information from the user 60.

In one embodiment, the object device 50 may be configured to communicate with one or more auxiliary devices other than another object device 50 or a user. The auxiliary device may be configured differently from the object device 50—e.g., the auxiliary device may not include a processor 51, and instead, may include at least one direct connection and/or a communication interface for transmission or receipt, or both, of information with the object device 50. For instance, the auxiliary device may be a solenoid that accepts an input from the object device 50, or the auxiliary device may be a sensor (e.g., a proximity sensor) that provides analog and/or digital feedback to the object device 50.

The system 100 in the illustrated embodiment may be configured to determine location information in real-time with respect to the remote device 20. In the illustrated embodiment of FIGS. 1, 2, and 5, the user 60 may carry the remote device 20 (e.g., a smartphone or mobile device). The system 100 may facilitate locating the remote device 20 with respect to the object 10 (e.g., a vehicle) in real-time with sufficient precision to determine whether the user 60 is located at a position at which access to the object 10 or permission for an object command should be granted.

For instance, in an embodiment where the object 10 is a vehicle, the system 100 may facilitate determining whether the remote device 20 is outside the vehicle but in close proximity, such as within 5 feet, 3 feet, or 2 feet or less, to the driver-side door 15. This determination may form the basis for identifying whether the system 100 should unlock the vehicle. On the other hand, if the system 100 determines the remote device 20 is outside the vehicle and not in close proximity to the driver-side door (e.g., outside the range of 2 feet, 3 feet, or 5 feet), the system 100 may determine to lock the driver-side door. As another example, if the system 100 determines the remote device 20 is in close proximity to the driver-side seat but not in proximity to the passenger seat or the rear seat, the system 100 may determine to enable mobilization of the vehicle. Conversely, if the remote device 20 is determined to be outside close proximity to the driver-side seat, the system 100 may determine to immobilize or maintain immobilization of the vehicle.

The object 10 may include multiple object devices 50 or variant thereof, such as an object device 50 including a sensor 40 coupled to an antenna array 30, in accordance with one or more embodiments described herein.

Micro-location of the remote device 20 may be determined in a variety of ways, such as using information obtained from a global positioning system, one or more signal characteristics of communications from the remote device 20, and one or more sensors (e.g., a proximity sensor, a limit switch, or a visual sensor), or a combination thereof. An example of microlocation techniques for which the system 100 can be configured are disclosed in U.S. Nonprovisional patent application Ser. No. 15/488,136 to Raymond Michael Stitt et al., entitled SYSTEM AND METHOD FOR ESTABLISHING REAL-TIME LOCATION, filed Apr. 14, 2017—the disclosure of which is hereby incorporated by reference in its entirety.

In one embodiment, in the illustrated embodiment of FIGS. 1-5, the object device 50 (e.g., a system control module (SCM)) and a plurality of sensors 40 (coupled to an antenna array 30 as shown in FIG. 3) may be disposed on or in a fixed position relative to the object 10. Example use cases of the object 10 include the vehicle identified in the prior example, or a building for which access is controlled by the object device 50.

The remote device 20 may communicate wirelessly with the object device 50 via a communication link 140. The object device 50 or another device of the system may be configured to determine one or more signal characteristics of the communications, such as a phase characteristic, a signal strength, a time of arrival, a time-of-flight, or an angle of arrival, or a combination thereof.

Optionally, the plurality of sensors 40 may be configured to monitor (e.g., sniff) the communications of the communication link 140 between the remote device 20 and the object device 50 to determine one or more signal characteristics of the communications, such as a phase characteristic, a signal strength, a time of arrival, a time-of-flight, or an angle of arrival, or a combination thereof. The determined signal characteristics may be communicated or analyzed and then communicated to the object device 50 via a communication link 130 separate from the communication link between the remote devices 20 and the object device 50. Additionally, or alternatively, the remote device 20 may establish a direct communication link with one or more of the sensors 40, and the one or more signal characteristics may be determined based on this direct communication link.

The one or more sensors 40 may be disposed in a variety of positions on the object 10, such as the positions described herein, including for instance, one or more sensors 40 in the door panel and one or more other sensors in the B pillar.

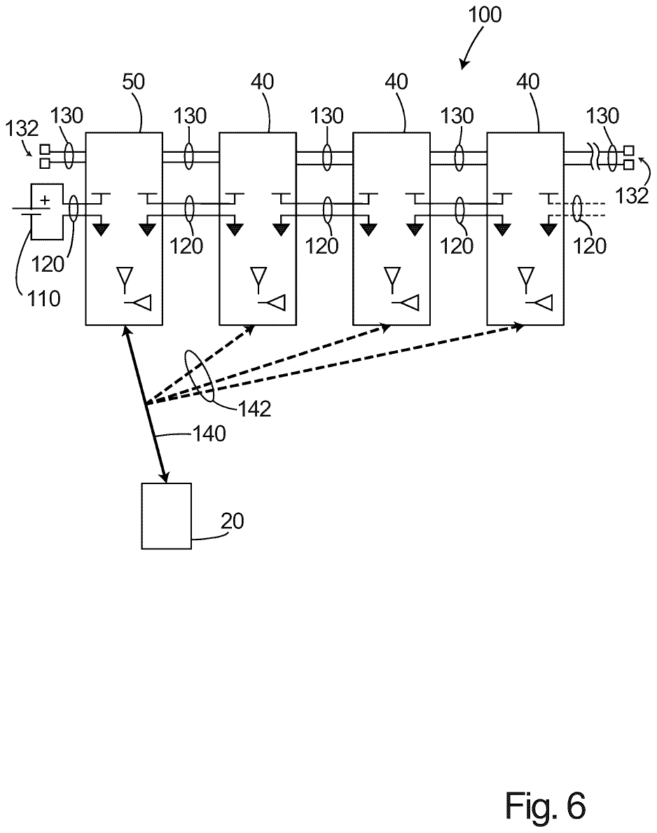

The object device 50 and the one or more sensors 40 may be powered via a power bus 120. The power bus 120 may be daisy chained from one device to the next as depicted in the illustrated embodiment of FIG. 6. Alternatively, the power bus 120 may be provided in the form of a star connection with power being supplied from one location to multiple locations via separate connections. Power supply and associated architecture is not limited to any one type—for instance, power may be distributed via both daisy chain and star connection configurations. The power bus 120 may be coupled to a power supply 110 to facilitate distributing power to devices in the system 100.

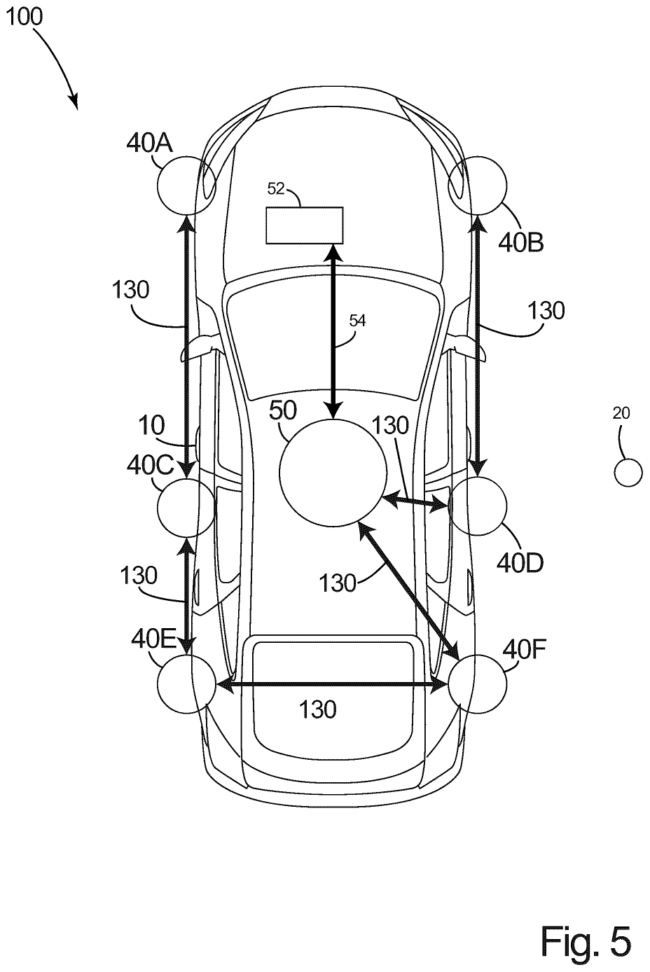

The system 100 in the illustrated embodiment may be configured to determine location information in real-time with respect to the remote device 20. In the illustrated embodiment of FIG. 5, a user may carry the remote device 20 (e.g., a smartphone). The system 100 may facilitate locating the remote device 20 with respect to the object 10 (e.g., a vehicle) in real-time with sufficient precision to determine whether the user is located at a position at which access to the object 10 or permission for an object 10 command should be granted.

In the illustrated embodiment of FIG. 6, the communication link 130 is distributed from one device to another and includes a terminator 132 at each end. The communication link 130 among the devices may be a shared link or a separate link for each device, or a combination thereof. For instance, the communication link 130 may be shared among two or more devices as depicted, and additionally or alternatively, the communication link 130 may be established separately from one device to another device. A device may communicate via more than one separate communications link 130, and may be configured to relay communications from one communication link 130 to another communication link 130.

The remote device 20 may communicate wirelessly with the object device 50 via a communication link 140, such as a BLE communication link or an Ultra-Wideband (UWB) communication link.

Optionally, the plurality of sensors 40 may be configured to monitor (sniff) the communications of the communication link 140 between the remote device 20 and the object device 50 as shown in phantom lines 142. The monitored communications or transmissions may correspond to a tone exchange (one-way or two-way) between the object device 50 and the remote device 20. Based on the monitored communications, a sensor 40 may determine one or more signal characteristics of the communications as described herein, including a phase characteristic of the communications. Additional or alternative signal characteristics include a signal strength, time of arrival, time-of-flight, angle of arrival, or a combination thereof. The determined signal characteristics may be communicated or analyzed and then communicated to the object device 50 via the communication link 130 separate from the communication link 140 between the remote device 20 and the object device 50.

Additionally, or alternatively, as described herein, the remote device 20 may establish a direct communication link with one or more of the sensors 40, and the one or more signal characteristics may be determined based on this direct communication link. For instance, as described herein, the remote device 20 and a sensor 40 may perform a tone exchange as a basis for determining a distance between the sensor 40 and the remote device 20. The direct communication link may be established according to the BLE protocol; however, the present disclosure is not so limited—the direct communication link may be any type of link or links, including Ultra-Wideband (UWB).

It is to be understood that an object 10, such as a vehicle, may include a number of sensors 40 (A-F) that can be greater than or less than the number shown in the illustrated embodiment of FIGS. 1 and 2. Depending on the implementation, some number of sensors 40 may be integrated in a vehicle.

As described herein, one or more signal characteristics, such as a phase characteristic, a signal strength, time of arrival, time-of-flight, and angle of arrival, may be analyzed to determine location information about the remote device 20 relative to the object 10, as an aspect of the object 10, or the object device 50, or a combination thereof. For instance, a phase rotation of a tone transmission, and optional re-transmission, or a phase characteristic indicative of a phase rotation may form the basis for determining a distance between an object device 50 or a sensor 40 and the remote device 20. Additional examples of signal characteristics include time difference of arrival or the angle of arrival, or both, among the sensors 40 and the object device 50 may be processed to determine a relative position of the remote device 20. The positions of the one or more antenna arrays 30 relative to the object device 50 may be known so that the relative position of the remote device 20 can be translated to an absolute position with respect to the antenna arrays 30 and the object device 50.

Additional or alternative types of signal characteristics may be obtained to facilitate determining position according to one or more algorithms, including a distance function, trilateration function, a triangulation function, a lateration function, a multilateration function, a fingerprinting function, a differential function, a time-of-flight function, a time of arrival function, a time difference of arrival function, an angle of departure function, a geometric function, or any combination thereof.

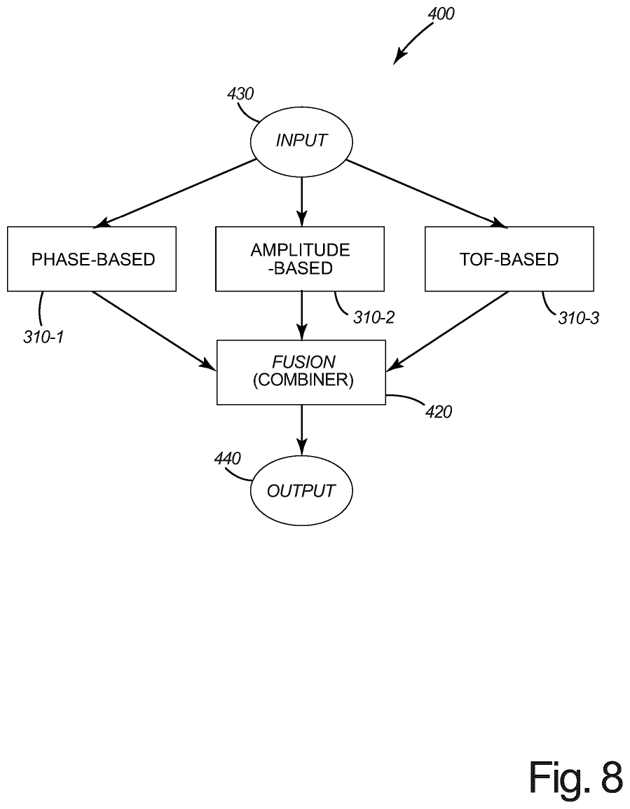

In FIG. 8, a locator system 400 is shown and depicted with multiple locator processors 310 designated 310-1, 310-2, 310-3 for discussion purposes. The locator processors of the locator system 400, e.g., the locator processor 310-1, 310-2, 310-3, may be similar to the locator 310 described herein, and may include one or more aspects of the locator processor 310. Likewise, the locator processor 310 described herein may include one or more aspects of the locators described in conjunction with the locator system 400. The locator processors 310-1, 310-2, 310-3 correspond respectively to a phase-based locator processor, an amplitude-based processor, and a time-of-flight locator processor-however, it is to be understood that the processors may be configured differently and according to one or more different modalities as described herein.

In the illustrated embodiment of FIG. 8, the locator system 400 is configured to receive input 430 similar to the input 316 described in conjunction with the locator processor 310. The input 430 may be different, the same, or overlapping in some respects for the locator processors 310-1, 310-2, 310-3. In other words, although the input 430 is shown being provided to each of the plurality of locator processors 310-1, 310-2, 310-3, and the input 430 is described as including multiple types of data, it is to be understood that not all types of data in the input 430 may be provided to each of the plurality of locator processors 310-1, 310-2, 310-3, and that not all of the locator processors 310-1, 310-2, 310-3 may receive the same data as part of the input 430. For instance, in the case of the input 430 including first data and second data, the first data may be provided to one locator and both the first and second data may be provided to another locator.

The locator system 400 in the illustrated embodiment includes a locator 310-1 configured different from the locator processor 310-2, 310-3. For instance, the locator processor 310-1 may be a first type of locator configured to generate an output based on a phase-based aspects for the input 430 received by the locator 410-1.

In the illustrated embodiment, the locator 410-2 is a second type of locator different from the first type of locator. However, it is to be understood that the locator 410-2 may be the same type of locator as the first locator. The second type of locator in the illustrated embodiment is configured to generate an output based on amplitude-based aspects of the input 430 received by the locator 410-2.

The locator 410-3 in the illustrated embodiment is a third type of locator different from the first and second types of locators. However, it is to be understood that the locator 410-3 may be the same type of locator as the first locator or the second locator, or both.

The outputs from the locators 410-1, 410-2, 410-3 may be provided to a fusion processor 420 (e.g., a combiner) operable to generate an output 440 indicative of a location of the mobile device 20 relative to the object 10. The fusion processor 420 may be a type of locator operable to receive a plurality of inputs and to generate an output indicative of a location of the mobile device 20 relative to the object 10. However, in contrast to one or more of the locator processor 310-1, 310-2, 310-3, the fusion processor 420 may receive, as input, outputs from a plurality of locator processors 310-1, 310-2, 310-3. The fusion processor 420 may be disposed on any component of the system 100, and that component may or may not include one or more of the locators 310-1, 310-2, 310-3.

The output 440 from the fusion processor 420 may vary from application to application. Example outputs include coordinates of the mobile device 20 (e.g., X, Y, Z and/or rho, theta, phi), and a zone (e.g., an unlock zone, inside the vehicle, front passenger seat). Additional examples are described in U.S. application Ser. No. 17/896,207, entitled DISTRIBUTED GENERATION OF REAL-TIME LOCATION, to Cooper et al., filed Aug. 26, 2022—the disclosure of which is incorporated by reference herein in its entirety.

In one embodiment, the output 440 from the fusion processor 420 may be provided to another fusion processor operable to receive the output 440 as input and output from another fusion processor or a locator, or a combination thereof.

As described herein, the locator processors 310-1, 310-2, 310-3 and the fusion processor 420, or a combination thereof, may be disposed on one or more separate components of the system 100. For instance, the locator processor 310-1 may be disposed in any component of the system 100, such as in the object device 50 or a remote device 40. This component on which the locator processor 310-1 is disposed may be different from a component on which one or more other locators are disposed.

### II. System Device Overview

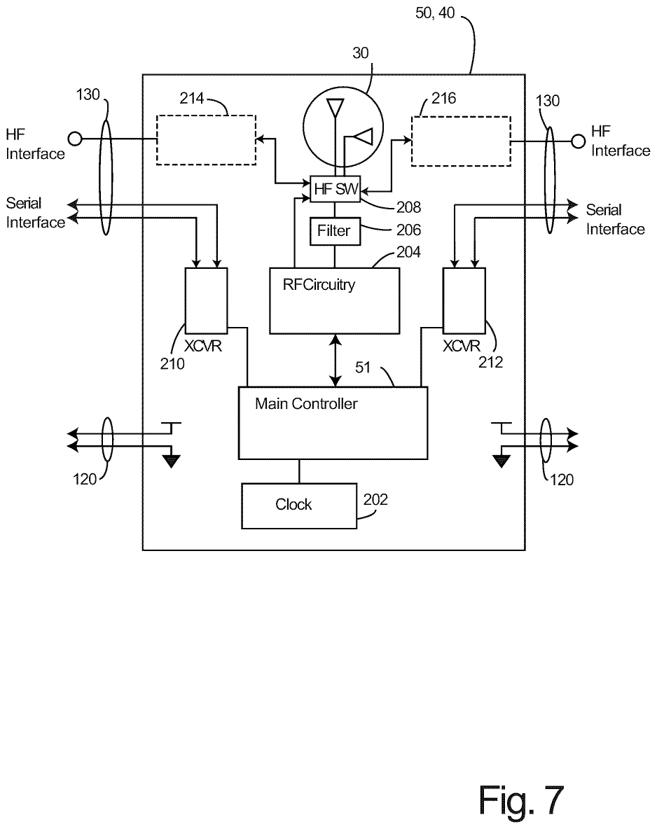

In the illustrated embodiment of FIG. 7, the object device 50 in one aspect is shown in further detail. The structure and configuration of described in conjunction with FIG. 7 may be incorporated into a sensor 40 or an object device 50—but for purposes of disclosure, the structure and configurations described in conjunction with the object device 50.

The object device 50 in the illustrated embodiment of FIG. 7 includes several components, one or more of which may be provided in a commercial embodiment. The object device 50 in some instances may be described as an anchor disposed on the object 10.

The object device 50 may include RF circuitry 204 operable to control transmission and reception of HF signals. The RF circuitry 204 may be operably coupled to an antenna array 30, which may include one or more antennas. An example configuration of an antenna array 30 is described in U.S. Nonprovisional patent application Ser. No. 18/096,666 to Osman Ahmed et al., entitled SYSTEM AND METHOD FOR COMMUNICATING, filed Jan. 13, 2023—the disclosure of which is incorporated herein by reference in its entirety.

The RF circuitry 204 may be configured to supply or receive high-frequency signals from the antenna array 30 via filter circuitry 206 and a HF switch 208. The filter circuitry 206 may condition the signal output from the RF circuitry 204 for driving the antenna array 30. Conversely, the filter circuitry 206 may condition a signal received from the antenna array 30 for processing by the RF circuitry 204. The HF switch 208 may selectively direct input and output of HF signals, including HF supplied to and received from the antenna array 30.

In one embodiment, the RF circuitry 204 may be configured according to one embodiment to transmit and receive signals via a high-frequency interface of the communication link 130. Transmission and reception of HF signals in one embodiment may enable an object device 50 to communicate via a physical medium according to a communication protocol that is the same or similar to the one utilized by the antenna array 30 in the RF circuitry 204. For instance, the object device 50 may transmit and receive communications via a physical medium defined by the high-frequency interface that correspond to the BTLE communications, while also transmitting and receiving communications via the antenna array 30 that correspond to BTLE communications and/or UWB communications.

The HF switch 208 may selectively direct output from the RF circuitry 204 to the high-frequency interface of the communication link 130, and selectively direct input from the high-frequency interface of the communication link 130 to the RF circuitry 204. In one embodiment, the HF interface may be a single ended configuration, such as a coaxial conductor arrangement. Alternatively, the HF interface may be differential, and optionally include conditioning circuitry 214, 216 (e.g., a balun and/or an impedance transformer) for translating between a single ended output from the HF switch 208 and a differential output of the high-frequency interface of the communication link 130.

In one embodiment, the high frequency switch 208 and the conditioning circuitry 214, 216 may be absent, such that the communication link 130 is provided via a serial interface or another type of communication interface, as described herein.

In the illustrated embodiment, the object device 50 is configured to transmit and receive communications via separate high-frequency interfaces provided by separate communication links 130. In other words, the two communication links 130 in the illustrated embodiment are isolated from each other, such that communications received on one communication link 130 are not inherently transmitted or seen on the other communication link 130. As discussed herein, the object device 50 may be configured to relay communications from one of the communication links 130 to the other of the communication links 130. For example, communications received via one high-frequency interface may be directed to the RF circuitry 204, and may be related to the other high-frequency interface via the RF circuitry 204. The HF switch 208 may be in transition from one state to another state to facilitate relaying of such communications. It is to be understood, however, that in one or more embodiments described herein, communications transmitted via one of the communication links 130 may inherently pass to the other of the communication links 130.

The object device 50 may include a main controller 51 and may be configured to direct operation of the RF circuitry 204, as described herein. In one embodiment, the main controller 51 may control a tone exchange via the antenna array 30 to facilitate determining a one-way range or two-way range determination with respect to the remote device 20. Additionally, or alternatively, the object device 50 may sniff communications that pertain to a tone exchange and that occur between another object device (e.g., a sensor 40) and the remote device 20. In one embodiment, a sensor 40 may be configured to monitor or sniff communications that pertain to a tone exchange and that occur between the object device 50 and the remote device 20.

The main controller 51 may further direct transmission and reception of communications via the HF interface of the one or more communication links 130. As an example, the main controller 51 may direct transmission and reception of BTLE communications via the HF interface of the communication link 130. Information transmitted via the high-frequency interface of the communication links 130 may relate to one or more signal characteristics obtained with respect to communications received and/or transmitted via the antenna array 30. As an example, the information transmitted via the communication link 130 may be indicative of a phase rotation determined with respect to communications received and/or transmitted via the antenna array 30.

Additionally, or alternatively, the main controller 51 may utilize the high-frequency interface of the communication links 130 for time synchronization or time offset determination purposes. As discussed herein, a phase characteristic of a tone exchange is based at least in part on a time reference of the device. And because time is translatable to distance (and conversely distance to time) with respect to electromagnetic waves, determining the reference time of the sensor 40 may facilitate enhancing accuracy with respect to determining the phase characteristic and distance between the remote device 20 and the object device 50.

The object device 50 may include a clock 202 that operates an oscillator and generates one or more timing signals for operation of aspects of the object device 50, including the main controller 51 and the RF circuitry 204. In one embodiment, the clock 202 may be configured to generate a timing signal that the main controller 51 and/or the RF circuitry 204 may use as a basis for transmitting a tone exchange signal (e.g., an initiator signal). As described herein, the tone exchange signal may include transmissions according to a plurality of frequencies and a phase rotation with respect to such transmissions and may form the basis for a distance determination with respect to the object device 50 and the remote device 20.

In one embodiment, the object device 50 includes first and second transceivers 210, 212 coupled respectively to serial interfaces of the communication links 130. The transceivers 210, 212 may be CAN transceivers, but the present disclosure is not so limited. The transceivers 210, 212 may facilitate any type of serial or non-serial communications via the communication links 130, including but not limited to RS-485, LIN, Vehicle Area Network (VAN), FireWire, I2C, RS-232, RS-485, and Universal Serial Bus (USB).

The first and second transceivers 210, 212 may enable communications among devices (e.g., the object device 50 and a sensor 40). For instance, the object device 50 may transmit to a sensor 40, via the serial interface of the communication link 130, connection parameters for the communication link 140 to enable the sensor 40 to monitor communications between the object device 50 and the remote device 20. A sensor 40 may receive such communications via the first transceiver 210 and relay the communications to another device (e.g., another sensor 40) via the second transceiver 212.

Optionally, the object device 50 may include a communication link 130 configured with a serial interface without the high-frequency interface or a high-frequency interface without the serial interface. Communications described herein with respect to one interface and not the other may be communicated via the interface provided by the communication link 130. For instance, the communication link 130 may include a high-frequency interface without the serial interface, and communications described in connection with the serial interface may be transmitted via the high-frequency interface. The high frequency interface and/or the serial interface may be wired or wireless.

The communication interface of the main controller 51 may facilitate any type of communication link, including any of the types of communication links described herein, including wired or wireless. The communication interface may facilitate external or internal, or both, communications. For instance, the communication interface may be coupled to the RF circuitry 204 to enable communications via one or more of the antenna array 30 and the HF interface of the communication link 130.

As another example, the communication interface of the main controller 51 may facilitate a wireless communication link with another system component in the form of the remote device 20, such as wireless communications according to the Wi-Fi standard or UWB, or any combination thereof. As another example, the communication interface of the main controller 51 may include a display and/or input interface for communicating information to and/or receiving information from the user.

### III. Ranging Overview

Bluetooth Channel Sounding with phase-based ranging is considered to be a powerful approach for estimating distance and direction. However, this approach may face challenges in real-world environments due to noise, multipath propagation, and phase wrapping. Advanced post-processing algorithms, including one or more of phase unwrapping, outlier filtering, and combining phase with amplitude measurements, may be utilized to improve the robustness and accuracy of the range estimation.

Phase unwrapping errors may occur when rapid movement between devices causes the measured phase to change by more than one full cycle (2π radians) between successive measurements, leading to ambiguity in determining the actual phase shift. Increasing the frequency of ranging updates reduces the time between measurements, which in turn reduces the amount of phase change that can occur between them. By capturing phase measurements more frequently, the system 100 may be better able to track continuous phase evolution over time, thereby minimizing the likelihood of unwrapping errors. In other words, a higher update rate may improve temporal resolution, helping to ensure that each phase transition is correctly interpreted, even in dynamic or high-mobility scenarios.

A phase-based ranging system according to one configuration may be sensitive to various sources of error, such as in dynamic environments where devices are in motion. For applications focused on localizing devices carried by individuals walking during routine activities, movement at a velocity of 1.5 to 3 m/s may introduce effects that degrade the accuracy of range estimation. The velocity range of 1.5 to 3 meters per second is discussed herein for purposes of disclosure because this velocity range reflects typical human walking speeds, particularly in real-world use cases like approaching or walking around a vehicle. This velocity range is also useful because it represents the velocities at which motion-induced phase changes—such as Doppler shift, increased phase wrapping frequency, and time-varying multipath effects-become non-negligible relative to the update rate and latency of Bluetooth channel sounding systems. Velocities less than 1.5 m/s can still introduce challenges, particularly in environments with dense multipath or limited line-of-sight, but these effects are generally less pronounced and more easily mitigated by filtering and processing techniques. As velocity increases beyond 1.5 m/s, however, the rate of phase change increases, the likelihood of phase wrapping grows, and the time between samples becomes more impactful-all of which elevate the usefulness for compensation strategy according to one or more embodiments described herein.

The effects of movement at velocity may include the Doppler effect, phase changes due to motion, system latency, multipath interference, and outlier handling. One or more embodiments according to the present disclosure may enhance phase-based ranging accuracy and strategies to mitigate these other and/or other potential errors and effects.

### A. Doppler Effect

The relative motion between the devices (e.g., remote device 20 and an object device 50) introduces a Doppler shift, which affects the perceived frequency of the received signal. This change in frequency may alter the phase measurements across channels. Since phase-based ranging relies on precise phase difference measurements, the Doppler shift can distort the estimated phase and lead to incorrect distance estimates.

The Doppler shift f_{d} can be approximated by:

$${f}_{d} = \frac{v}{λ} ,$$

where v is the velocity and A is the wavelength of the signal.

For instance, the motion of the device at 1.5 m/s may cause a Doppler shift that can distort phase measurements. For Bluetooth operating at 2.4 GHz (wavelength of 0.125 meters), the Doppler shift is approximately 12 Hz. The Doppler shift may be different for different communication methodologies (e.g., a communication methodology other Bluetooth, such as Ultra-wideband)

The Doppler shift may introduce phase distortion over time. While a Doppler shift of 12 Hz is relatively small, it can result in continuous drift in the phase measurements, particularly if the system does not account for motion or update phase measurements frequently enough. The phrase “update phase measurements frequently enough” may refer to the rate at which Bluetooth Channel Sounding (CS) procedures are performed—i.e., how often a complete sweep across multiple frequency channels is initiated and received between the two devices. In a CS procedure according to one embodiment, ranging accuracy depends on the temporal resolution of these measurements relative to the rate of motion-induced phase change.

A Doppler shift of 12 Hz (such as that induced by a person walking at ~1.5 m/s at 2.4 GHz) may result in measurable phase drift over time. If the CS procedure is repeated too infrequently, such as once every several hundred milliseconds, then this accumulated phase distortion can lead to errors in unwrapping and distance estimation—particularly when phase differences are interpreted as range over time. Therefore, “frequently enough” in one context may mean performing CS updates at a rate sufficient to track phase evolution without significant ambiguity. In the context of walking speeds, this implies update intervals on the order of tens of milliseconds (e.g., ≤50 ms) to maintain reliable tracking of phase and avoid degradation in accuracy, although it has been determined the interval can stretch out to 100-200 ms for applications depending on the configuration.

The frequency at which phase measurements is updated to compensate for continuous drift may be determined by the precision and accuracy targets for the application. The Doppler shift-induced error may cause a phase error corresponding to several centimeters, increasing over time with continued motion, particularly if the update rate is too slow or the system uses signal processing techniques that rely on estimating ranges across a span of several measurements over time. This Doppler shift ranging in the teens of Hz can introduce a small, continuous error in phase, such as when the remote device 20 moves quickly across different positions, causing a drift in the estimated range.

The phase error may be inherently measured in angular units (e.g., radians or degrees), and the impact of a phase error on distance estimation may depend on how the ranging algorithm maps phase across subcarriers to distance. To bridge that gap, a mathematical bound may be provided on how Doppler-induced phase error translates to range error within a channel sounding (CS) procedure.

For instance, when a device is in motion, the device introduces a Doppler shift, which may lead to a phase deviation over the duration of a channel sounding sweep. The Doppler-induced phase error can be approximated by:

Δφ≈2π×f_{d}×T, where:
Δφ is the phase error in radians,
f_{d} is the Doppler shift in Hz (which depends on velocity and carrier frequency),
T is the total duration of the sweep across channels.

Once this phase error is introduced, it can translate into a range estimation error. Using the basic phase-based range estimation relationship, the corresponding range error Δr is given by:

Δr=(c×Δφ)/(4π×Δf), where:
c is the speed of light (3×10⁸ m/s),
Δf is the frequency spacing between subcarriers.

For example, consider a person is walking at 1.5 m/s, which results in a Doppler shift f_{d}≈12 Hz for a 2.4 GHz carrier. If the CS sweep takes T=10 ms, the result is the following:

Δφ≈2π×12×0.01≈0.75 rad

Assuming Δf=1 MHz (typical for Bluetooth CS), the range error can be estimated:

Δr=(3×10⁸×0.75)/(4π×10⁶)≈18 cm

This may be considered a worst-case upper bound, assuming the phase error accumulates coherently across the frequency sweep. However, in many systems in practice, the actual impact may be less due to averaging across channels and temporal filtering.

It is noted that a changing multipath is often the dominant source of variation in practice, particularly in reflective environments like parking lots. The distinction in one embodiment of the present disclosure is that motion contributes to error both directly via Doppler-induced phase distortion and indirectly by altering the multipath profile. While Doppler-related phase drift may introduce small-to-moderate range errors (a few to tens of cm), rapidly evolving multipath due to motion (e.g., walking past a car) can cause larger, less predictable jumps in apparent range.

In one embodiment, motion alone, during the short interval of a single CS sweep, may introduce a bounded phase distortion that maps to a relatively small range error—but when combined with multipath variation, the effective error becomes more pronounced.

For a 25 ms CS procedure duration, when a device moves, the Doppler effect may cause a frequency shift, which accumulates as a phase error during the procedure. The approximate phase deviation Δφ due to this Doppler shift as noted above may correspond to the following:

Δφ≈2π×f_{d}×T

Assume a walking speed of 1.5 m/s and a Bluetooth carrier frequency of 2.4 GHz, which gives f_{d}≈(v/A)=(1.5 m/s)/(0.125 m)=12 Hz. Now, with a T=25 ms=0.025 s, the phase deviation becomes: Δφ≈2π×12×0.025≈1.884 rad. To convert this phase deviation into an approximate range error Δr, as noted above, the following relationship may be used, Δr=(c×Aφ)/(4π×Δf). Assuming c=3×10⁸ m/s (speed of light), Δf=1 MHz (frequency spacing between subcarriers in Bluetooth), then: Δr≈(3×10⁸×1.884)/(4π×10⁶)≈45 m/(12.566)≈3.58 meters. Even though a Doppler shift of 12 Hz seems small, if it is uncorrected over a 25 ms CS sweep, the Doppler shift may introduce nearly 1.9 radians of phase shift, translating to a range estimation error of ~3.6 meters under this more simplified model. This demonstrates that motion during the procedure—particularly over longer CS durations—can meaningfully distort the resulting range if there is no compensation for Doppler. In practice, dynamic multipath may contribute more significantly to error than Doppler shift alone, particularly in reflective environments like parking lots. But under moderate speeds, Doppler effects are not negligible and may be modeled or compensated for in a ranging system according to one embodiment.

### B. Phase Changes Due to Movement

If the remote device 20 is moving, such as at or around 1.5 to 3 m/s, the phase measurements may continuously change, as phase is a function of distance. Over time, this rapid phase change may cause more frequent phase wrapping, complicating the phase unwrapping process.

In one embodiment, the system 100 may be configured to support a wide range of relative motion speeds between devices, extending beyond typical pedestrian walking speeds. While earlier examples reference a velocity of 1.5 m/s for understanding the relationship between motion and measurement update intervals, this value is not a system limitation but rather a representative use case. In practice, the system 100 may be configured to remain robust under more dynamic scenarios, including those encountered in certification testing environments that use 2.1 m/s, and real-world use cases such as jogging, hand movement, or interaction between moving vehicles and pedestrians. Accordingly, the ranging and tracking algorithms described herein according to one or more embodiments may be configured to maintain substantial coherence and to substantially suppress unwrapping and multipath errors at relative speeds up to approximately 25-30 m/s, which may be observed in scenarios like remote park assist, vehicle-pedestrian safety systems, or handheld-to-wearable interactions in transit. To meet these demands, the system 100 may adapt its channel sounding parameters, update rate, and signal processing pipeline (e.g., Doppler compensation, filtering, and fusion strategies) based on the detected dynamics of the environment and motion context.

If the system 100 does not track the device fast enough, errors may accumulate due to missed or inaccurate phase unwrapping, leading to incorrect distance estimates. This is a larger concern if the system's update rate is slow relative to the device's motion.

As the remote device 20 moves at a velocity, such as 1.5 m/s, the phase wrapping frequency increases because phase wraps every 2π radians (or every wavelength). For instance, given a wavelength of 0.125 meters at 2.4 GHz, for a velocity of 1.5 m/s, the remote device 20 moves through one wavelength roughly every 83 milliseconds. Phase unwrapping errors may occur if the system fails to track the phase changes accurately, such as in high-multipath environments. This may lead to incorrect distance estimates. The error due to incorrect phase unwrapping may result in errors of up to half a wavelength (i.e., ~6.25 cm) per cycle of incorrect unwrapping.

### C. System Latency

Bluetooth devices often have a channel-sounding interval on the order of milliseconds. Other types of communication methodologies may be similar or different in terms of update rate and/or intervals. If the update rate is too low (i.e., the time between phase measurements is long compared to the motion), the remote device 20 may move a significant distance between measurements. If phase measurements are taken too infrequently, the distance covered by the remote device 20 between measurements may lead to phase inconsistencies and degraded ranging accuracy.

The update rate described herein may correspond to the rate at which successive channel sounding procedures are performed—i.e., how often the full 72-channel (or similar) procedure is executed. This update rate may be every 100 ms, 200 ms, etc., depending on the system. While each individual procedure may include high-rate sampling (e.g., ~87 μs per measurement across subcarriers and antennas), motion during the entire 25 ms procedure or the time between procedures (inter-procedure interval) may still result in phase inconsistencies if not properly accounted for.

It is noted that Bluetooth devices may have a channel-sounding procedure interval on the order of tens to hundreds of milliseconds. While each procedure may internally collect phase data across subcarriers and antennas at microsecond-scale intervals, motion of the device during the duration of the procedure or between procedures may result in meaningful physical displacement. If the time between procedures is too long, or if a procedure itself spans enough time for motion-induced phase evolution, this can lead to inconsistencies in phase measurements particularly when aggregating results over time. Such inconsistencies may degrade the accuracy of the resulting range estimates, such as in dynamic or multipath-rich environments.

Faster sampling or more frequent phase measurements may help to maintain a consistent phase-based ranging result, despite the motion of the remote device 20.

The phrase “faster sampling or more frequent phase measurements” may refer specifically to the rate at which complete ranging procedures are executed over time rather than the individual sampling intervals within a single procedure. While each channel sounding procedure may collect phase measurements rapidly for example, one measurement every ~87 microseconds over a ~25 ms window the overall rate at which those procedures are repeated (i.e., the inter-procedure interval) may determine how frequently new, updated range estimates are generated. Increasing this update rate (i.e., executing procedures more frequently) may allow the system to better track changes in the device's position over time, particularly when the device is moving. If the time between full procedures is too long, even if intra-procedure sampling is dense, the system may miss or misinterpret movement that occurs between procedures, resulting in degraded range accuracy due to phase inconsistencies or incorrect unwrapping. Thus, maintaining a high procedure execution rate may be helpful for consistent and accurate phase-based ranging in dynamic environments.

### D. Multipath and Dynamic Environment

In a dynamic environment, where objects or the mobile device 20 move, the relative signal paths may change due to multipath propagation (e.g., signal reflections from surfaces like walls or cars). As the remote device 20 (and/or the object device 50) moves, the multipath components may fluctuate, potentially causing large variations in the measured phase. This results in phase noise and fading, adversely affecting the ability to separate direct path signals from multipath signals.

To reduce the effects of multipath, the system 100 may employ algorithms that can incorporate more sophisticated techniques like Kalman filtering or multiple antenna arrays to isolate the direct path signal. Additionally, or alternatively, combining amplitude and phase data may help filter out multipath-induced errors.

For instance, environments such as parking lots, office buildings, laboratories, retail stores, and even most modern homes contain many reflective surfaces (e.g., vehicles, walls, furniture, glass, appliances) that contribute to multipath propagation. In these settings, the signal transmitted from a device reflects off various objects and surfaces, reaching the receiver via multiple indirect paths in addition to the direct line-of-sight (LOS) path. Each reflected path may introduce distinct delays and phase shifts, which interfere with the LOS signal. These multipath effects may contribute to both phase noise and signal fading, degrading the ability of the system to isolate the direct path. As a result, significant ranging errors may occur in both phase-based and amplitude-based measurements. The magnitude of these errors can vary widely depending on the environment, ranging from several centimeters to multiple meters. In dense multipath scenarios whether an outdoor parking lot surrounded by vehicles or a cluttered indoor space such as a home or office-range estimation errors can readily exceed 1 meter unless specific countermeasures are employed.

### E. Systemic Noise and Ranging Outliers

The movement of the mobile device 20 may introduce noise and rapid phase changes that can produce outliers in the phase data. This can lead to false distance estimates unless post-processing techniques are applied to smooth the phase data and handle these outliers.

Smoothing algorithms (e.g., low-pass filtering or Kalman filters) may be utilized to reduce the noise caused by rapid motion. Additionally, use of an error handling approach, such as outlier detection based on tone quality, may help to mitigate these errors.

The sampling rate of the system 100 (e.g., how often it updates phase measurements) becomes a consideration when one of the devices (e.g., the remote device and/or the object device 50) is moving. If the system 100 takes too long between phase measurements, the device may have moved a significant distance, leading to phase tracking errors. Given a velocity of 1.5 m/s, the device moves 1.5 cm every 10 ms. A slow update rate may lead to errors because the system 100 may miss intermediate positions of the device. A slow sampling rate or high latency may result in distance errors ranging from a few centimeters to several decimeters, depending on how much motion occurs between measurements.

The term “sampling rate” in this context may refer not to the individual phase samples collected during the execution of a channel sounding (CS) procedure—such as those acquired across multiple subcarriers and antennas over the course of ~25 ms but rather to how often a complete CS procedure is executed. That is, the sampling rate may correspond to the interval between successive full phase measurement updates available for use in tracking the relative position of a moving device. While within a single procedure the motion-induced displacement is typically small (e.g., only a few centimeters at walking speed), and thus may have limited impact in the absence of multipath, the effects of motion are significantly amplified when combined with multipath interference. In particular, even small shifts in position can cause substantial changes in the dominant multipath components observed during a CS procedure-resulting in large apparent changes in phase across channels. If procedures are spaced too far apart in time (i.e., a slow procedure execution rate), the system may miss these motion-induced changes in multipath conditions, which can lead to discontinuities or tracking errors in the estimated range. These errors may manifest as jumps or inconsistencies in the range estimate between procedures, and depending on the environment and motion profile, may range from a few centimeters to decimeters.

Phase tracking errors may mean the inaccuracies that arise when the system attempts to maintain a consistent estimate of the phase (and thus inferred distance) across successive measurements, particularly when the underlying physical conditions—such as the relative position of the device and the multipath environment—are changing. In a phase-based ranging system, accurate tracking of the unwrapped phase across frequency channels or over time may be useful to derive a stable and reliable range estimate. If the device moves significantly between channel sounding (CS) procedures, or if the multipath environment changes rapidly (even with small motion), the apparent phase values can shift unpredictably. When the system attempts to reconcile these shifts with past measurements-assuming only gradual or linear change—it may misinterpret the phase deltas, leading to incorrect unwrapping, abrupt jumps in range, or unstable tracking. These are what are referred to as “phase tracking errors”—they represent a breakdown in the continuity or coherence of the estimated phase due to either under-sampling in time or unmodeled dynamics in the channel.

### IV. Range Accuracy in Multipath Environments

Characterizing the error due to motion in a phase-based ranging system, particularly in a multipath environment such as a parking lot, involves an understanding of the various sources of error and how they compare to the expected range accuracy in such an environment.

### A. Expected Accuracy in a Static Environment

In a static scenario where neither the initiator (e.g., an object device 50) nor the reflector (e.g., a remote device 20) is in motion, a Bluetooth Channel Sounding approach according to one embodiment may use phase-based ranging to achieve accuracy in the range of 30 cm to 1 meter, depending on environmental factors and the number of antennas or channels used. This is primarily due to multipath, noise, and interference.

In multipath-rich environments such as parking lots, the range accuracy typically degrades. Without advanced signal processing techniques to mitigate multipath (e.g., filtering, multiple antennas, outlier rejection), the accuracy can drop to 1 meter or more. In highly reflective environments, such as near large metal objects (e.g., cars), errors can easily exceed 1 meter.

B. Error Due to Motion vs. Static Range Accuracy

A comparison of errors introduced by motion of a mobile device 20 on the order of about 1.5 m/s may be made relative to the expected static accuracy where the mobile device 20 is motionless. The velocity of 1.5 m/s is used for purposes of discussion—the velocity may be different depending on the application.

In a multipath environment without motion, accuracy may be around 1 meter or less. Doppler shift at 12 Hz resulting from motion of the mobile device 20 may introduce additional phase drift, but this error is considered small (i.e. a few centimeters) compared to multipath effects. Depending on the system processing techniques, the cumulative impact of Doppler shift over time may increase errors, such as with slow update rates.

With respect to phase wrapping and unwrapping errors, the static phase unwrapping may have an error of 5-10 cm due to noise and reflections. Motion of the mobile device 20 increases the frequency of phase wrapping, leading to potential unwrapping errors that may introduce errors of around 6 cm per cycle. While this 6 cm error may potentially occur at every channel, in general, the phase unwrapping errors are likely to be sparse and cancel out over a 72-channel procedure. However, if phase unwrapping errors include a systemic bias and accumulate, the total error may exceed this by a large margin.

Without motion, multipath may still result in errors that can range from 10 cm to over 1 meter in highly reflective environments, such as parking lots. The movement of the device may make multipath even more dynamic, as the relative positions of the transmitter, receiver, and reflectors change due to motion. This may lead to rapidly fluctuating phase measurements, increasing the overall error beyond 1 meter.

With respect to system latency and sampling rate, in a static scenario, slower sampling does not have as much of an impact on accuracy. Range estimates may settle within the static accuracy bounds. In contrast, if the system 100 is unable to sample phase measurements fast enough such as may happen in fragmented procedures, movement of the remote device 20 may result in errors as large as 15 cm per 100 ms of delay. Over longer periods, this effect may accumulate, further degrading accuracy.

As an example, overall error may be estimated in a motion scenario as follows. The remote device 20 may be provided in a highly reflective environment (e.g., like a parking lot), and the range accuracy may already degrade to around 1 meter or more due to multipath. With motion (1.5 m/s):
Doppler shift may contribute a few centimeters of drift over time.
Phase wrapping/unwrapping errors may contribute errors on the order of 6 cm per wrapping event, which may accumulate with rapid motion.
Multipath is likely to remain the dominant error source, with errors still around 1 meter or more.
Latency may result in errors of several centimeters to decimeters, potentially worsened if updates are delayed or too infrequent.

When one of the devices (e.g., an initiator or a reflector) in a channel sounding ranging system is moving at or around 1.5 m/s, the overall range error is likely to increase slightly beyond the static case (i.e., little to no motion), but multipath remains the primary contributor to large errors (up to several meters). Motion may exacerbate these errors, primarily through phase unwrapping issues and Doppler effects, but the additional error is on the order of tens of centimeters on top of the existing multipath-induced inaccuracies. Therefore, the total error in a dynamic, multipath environment may easily exceed 1-2 meters, depending on system latency, environment, and processing strategies.

### V. Phase-Error Mitigation Strategies

To mitigate the largest errors in phase-based ranging in a dynamic, multipath environment, such as a parking lot, the system may focus on addressing one or more of the primary sources of error: multipath propagation, phase wrapping/unwrapping errors, motion-induced Doppler shifts, system latency. One embodiment for mitigating one or more of these error sources (e.g., reducing an error source and/or improving ranging accuracy) includes one or more of the following: actively mitigating multipath propagation, integrating phase unwrapping approaches, reducing phase noise and jitter with filtering, and fusing the available sensed data and apriori data to form enhanced range estimates.

### A. Mitigating Multipath Propagation

Multipath is often the largest source of error, particularly in reflective environments. To reduce multipath impact, a channel-sounding ranging system may utilize one or more of the following: the use of multiple antennas for spatial diversity, a rake receiver, time-of-flight estimation, and multipath suppression algorithms.

It is noted that spatial and/or polarization diversity are supported according to one or more embodiments, as each offers distinct and complementary advantages in mitigating multipath interference. Spatial diversity refers to the use of physically separated antennas to capture signals arriving via different paths, thereby enabling techniques such as angle-of-arrival estimation, beamforming, or rake reception. Polarization diversity, on the other hand, involves the use of co-located antennas with differing polarization (e.g., vertical, horizontal, circular) to exploit the fact that multipath components often undergo polarization changes upon reflection. In environments where spatial separation is limited (e.g., due to form factor constraints), polarization diversity may be useful. Accordingly, the system may utilize spatial, polarization, or combined diversity strategies to enhance robustness against multipath.

It is noted that classical Bluetooth (BT) implementations do not employ a RAKE receiver in the traditional CDMA sense. The mention of a RAKE receiver in this disclosure is provided to more generally to describe the approach of resolving and coherently combining multiple delayed signal components to improve reception quality in multipath environments. While RAKE receivers are often associated with spread spectrum systems like CDMA, the same underlying principle—identifying and leveraging multipath components rather than treating them purely as interference—can apply to signal processing techniques in Bluetooth channel sounding or other RF systems.

It is noted that the system may employ multipath-resolving techniques based on RAKE-like behavior, even if they are not implemented as a classical RAKE receiver. In other words, mention of a RAKE receiver may be replaced with description of multipath combining algorithms to reflect one or more implementation for Bluetooth according to one or more embodiments of the present disclosure.

In one embodiment, the use of multiple antennas for spatial diversity may include deploying an array of antennas (multiple input, multiple output or MIMO) to distinguish between direct path signals and reflected multipath signals. By spatially separating antennas, the system 100 may measure the angle of arrival (AoA) of the signals and identify the direct path. MIMO architecture may help to isolate and prioritize the direct path signal, reducing the impact of multipath reflections.

It is noted that the conventional definition of MIMO in the context of communication systems—where independent data streams are transmitted and received simultaneously—is different from how antenna arrays are used in Bluetooth Channel Sounding (CS). For instance, in one embodiment, when referencing multiple antennas and spatial diversity, MIMO is not referred to in the throughput sense but rather to an antenna array configured and used to improve ranging performance by observing spatial variations in the received signal.

In other words, the antenna array in a Bluetooth CS system according to one embodiment may provide spatial diversity that can be exploited to help mitigate multipath by observing how the received signal characteristics (e.g., phase and amplitude) vary across the array. One embodiment may not perform comprehensive AoA estimation in the classical sense, but differences in signal phase or amplitude across antennas may be used to provide information about which path (e.g., direct vs. reflected) is more consistent or dominant. This can aid in rejecting outliers or downweighting multipath-dominated channels in post-processing or fusion steps.

In one embodiment, the ranging system 100 may include a rake receiver to exploit multipath by capturing delayed reflections and recombining them constructively. This approach may improve the signal-to-noise ratio (SNR) and reduce fading. By aligning and combining the multipath components, the system 100 may achieve accurate ranging even in reflective environments.

In systems that use CDMA, rake receivers may exploit wideband signal characteristics to resolve and align distinct multipath components separated in time. BLE, particularly in its standard form, may not provide sufficient bandwidth to support fine-grained time resolution for classical rake receiver implementations.

The mention of a rake receiver may indicate that, if the BLE Channel Sounding (CS) system is extended or combined with other modalities (e.g., time-of-flight, or even enhanced BLE PHYs with larger bandwidth), the system may exploit multipath diversity by identifying and coherently processing dominant delayed paths. For example, signal processing techniques applied across multiple antennas and channels may emulate a coarse version of this effect by detecting consistent delayed components through phase evolution or amplitude profile matching.

That said, in the BLE CS context, multipath mitigation strategies include using spatial or polarization diversity, tone quality-based outlier rejection, and sensor fusion (e.g., combining time-of-flight and RSSI with phase-based ranging).

In one embodiment, the system 100 may be configured to provide frequency diversity, which may be conducted through subcarrier averaging leverages based on multipath fading and noise typically affecting different frequency components of a signal in different ways. In a Bluetooth channel sounding system, the signal is transmitted across a series of frequency subcarriers (tones), each of which may experience different propagation characteristics due to the environment. Some tones may be distorted or attenuated by destructive interference, while others remain relatively unaffected. By averaging the phase measurements across multiple subcarriers, the system can mitigate the influence of localized fading or noise on any single tone. This averaging reduces the variance of the aggregate phase measurement, resulting in a more stable and accurate range estimate.

In practice, this approach can be implemented by first excluding unreliable tones using tone quality metrics or indicators (e.g., TQI or SNR), and then computing a weighted average of the unwrapped phase values across the remaining high-quality subcarriers. The weighting can be uniform or adaptive, based on each tone's measured quality. This averaging technique smooths out rapid fluctuations in phase caused by multipath or interference that may be isolated to a subset of tones. In effect, frequency diversity serves as a form of spatial filtering in the frequency domain, increasing the robustness of the ranging system in challenging environments such as near vehicles, walls, or other reflective surfaces. In one embodiment, the system 100 (e.g., a channel sounding ranging system) may be configured to complement phase-based ranging with time-of-flight measurements, if available. time-of-flight measures the absolute time delay of the signal and may help distinguish between the direct path and reflected paths. Channel-sounding procedures may include round trip time estimates based on the measurements of initiator-to-reflector and reflector-to-initiator channel measurements. time-of-flight is considered to be less susceptible to multipath and may provide an independent estimate of distance to compare with phase-based estimates, enhancing overall robustness.

Time-of-flight measurements are generally considered less susceptible to multipath interference compared to phase-based ranging because time-of-flight relies on identifying the earliest arriving signal path-typically corresponding to the direct line-of-sight (LoS) component-based on signal arrival time. Multipath reflections, by nature, arrive at the receiver with longer delays due to their extended paths involving reflections off surfaces like walls, vehicles, or other structures. As a result, time-of-flight-based systems can often filter or ignore these delayed components by selecting the first detectable signal edge or peak within a correlation window, assuming the direct path is detectable and not overly attenuated. This contrasts with phase-based methods, which integrate phase differences across multiple frequency channels and are more easily distorted by superposition of multiple paths with varying phases. While time-of-flight is not immune to multipath—such as when reflections are stronger than the direct path or when resolution is limited by bandwidth—it provides a complementary modality that is often more robust in complex environments when used alongside phase and amplitude data.

In one embodiment, the system 100 may apply one or more multipath suppression algorithms, such as matched filtering or adaptive filtering technique. These filters may separate multipath components from the direct signal using known signal characteristics and temporal differences. Suppressing the multipath signals may reduce noise and improve accuracy by focusing on the direct path signal.

### B. Handling Phase Wrapping and Unwrapping Errors

As described herein, phase unwrapping errors may cause significant inaccuracies in phase-based ranging, particularly in fast-moving scenarios such as those that may occur during remote park use cases. To reduce the impact of these errors, the system 100 may include one or more of the following: a high sampling rate, a phase unwrapping algorithm, and smoothing or filtering of the phase data.

In one embodiment, in the presence of motion, the system 100 may increase the sampling rate of the phase measurements. The faster the system can update, the less distance the moving device travels between measurements, reducing the chance of phase wrapping errors. A higher sampling rate may reduce the likelihood of large phase jumps between measurements that potentially lead to unwrapping errors.

The phrase sampling rate of the phase measurements is provided to broadly refer to the rate at which usable phase data is acquired for the purpose of range estimation, which may include both (1) the frequency of executed channel sounding (CS) procedures and (2) the effective sampling rate of phase measurements within each procedure.

In one embodiment for a Bluetooth CS configuration, a single procedure spans multiple channels and antenna paths (e.g., 72 channels over 4 antennas in ~25 ms), yielding phase measurements on the order of every ~87 ρs during the procedure. This intra-procedure phase sampling rate is already relatively high. However, when devices are moving, the total time between procedures becomes influential, such as if the system relies on combining or filtering phase results across multiple procedures. In such cases, a low procedure execution rate (i.e., infrequent CS events) can increase vulnerability to phase wrapping or rapid changes that are hard to track between procedures, particularly in fragmented operations.

So while the intra-procedure sampling may be fast, if the system only performs CS procedures sporadically (e.g., due to duty cycling or power constraints), then phase updates may not be frequent enough at the system level to capture motion accurately, which can lead to increased unwrapping errors. Therefore, in dynamic contexts, both intra-procedure and inter-procedure rates are relevant, and increasing the overall CS execution frequency (or fragment rate) may be necessary to maintain phase continuity and avoid phase tracking ambiguity.

In one embodiment, the system 100 may implement a phase unwrapping algorithm that uses prior knowledge of motion of the device and constraints on phase changes to identify and unwrap phase. Kalman filters or predictive filtering may help track motion of the remote device 20 more accurately. By tracking expected motion of the remote device 20 and correcting for phase jumps, the system 100 may avoid large unwrapping errors.

In one embodiment, the system 100 may be configured to apply a low-pass filter or Kalman filter to the phase data to reduce noise and phase jitter caused by rapid motion or multipath. Smoothing the phase data may reduce abrupt phase changes and prevent unwrapping errors that stem from noisy measurements.

The preceding paragraph is not intended to prescribe a single approach, but rather to describe multiple possible strategies that may be employed by the system to smooth phase data and reduce unwrapping errors caused by motion or multipath. Specifically, several alternatives are contemplated:

1. Using Prior Estimates from Previous Procedures:

The system may rely solely on phase (or fused) ranging data from earlier channel sounding procedures to estimate velocity or acceleration trends over time. These motion estimates may then be incorporated into a Kalman filter (or similar predictor) to smooth the current phase measurements or to anticipate expected phase changes. This strategy does not require any inertial sensor input.

2. Using IMU Data from the Device (Accelerometer/Gyro):

If available and permitted (e.g., via user/device consent or API integration), the system may incorporate real-time motion sensor data from an on-device IMU as an auxiliary input to the filter. This data may improve the filter's state estimate and help predict phase evolution during the CS procedure. This approach may enhance robustness in dynamic scenarios, but is not required.

3. Inferring Motion within a Single Procedure:

In cases where procedures are long enough (e.g., >25 ms) and motion is significant, the system may analyze the intra-procedure phase trends to infer motion over the span of a single CS operation. In this case, filtering or motion modeling may use only the internal dynamics of a given procedure.

In sum, no IMU requirement is implied. Rather, the specification allows for flexibility: systems may employ basic filtering based solely on RF data (e.g., phase history), enhanced filters using inferred motion, or—optionally—leverage IMU inputs for higher-fidelity motion compensation in scenarios where it is feasible or beneficial.

### C. Compensating for Motion-Induced Doppler Shifts

As described herein, motion may introduce Doppler shifts that can distort phase measurements. To mitigate these effects, the system 100 may implement one or more strategies: Doppler compensation, increased ranging update rates, and reduced system latency.

In one embodiment, the system 100 may be configured to estimate the Doppler shift based on the relative velocity between the devices (e.g., between the mobile device 20 and another device of the system [e.g., an object device 50 and/or a sensor 40]) and compensate for it in the phase measurements. To do this, the system 100 may be configured to calculate the shift using a known velocity and frequency of the signal. The velocity may be determined either from the phase measurement or via ancillary measurements such as from an accelerometer on the mobile device or a camera on a vehicle tracking the mobile device or the person carrying it. Correcting for the Doppler shift in real-time may improve the accuracy of phase measurements and prevent errors from accumulating over time.

In one embodiment, the system 100 may be configured to increase the frequency of ranging updates to more closely track the relative motion of the devices (e.g., between the mobile device 20 and another device of the system [e.g., an object device 50 and/or a sensor 40]). By reducing the time between updates, the system 100 may capture rapid changes in position and reduce or minimize the impact of motion on phase measurements. The system 100 may process these updates quickly enough to prevent phase drift, which may otherwise distort the distance estimates over time. More frequent updates stabilize the ranging results, improving accuracy and reducing the likelihood of errors accumulating as the devices move.

To prevent significant phase drift due to motion within or between channel sounding (CS) procedures, the system 100 may be configured to process ranging updates on the order of tens of milliseconds or faster, depending on the motion dynamics of the device. For example:
For pedestrian speeds around 1.5 m/s, the device moves ~1.5 cm every 10 ms. To prevent meaningful phase change between updates—such as in a Doppler-sensitive system—a procedure interval of 10-25 ms is typically sufficient to maintain coherence.
For moderate motion, such as someone jogging (~3 m/s), the system may benefit from updates every 5-10 ms to maintain coherent phase tracking and Doppler resolution.
If the system is not using Doppler-sensitive techniques and instead relies only on static per-procedure phase measurements (i.e., no cross-procedure coherence), the update rate is less critical, though higher rates still improve responsiveness to changes in motion and multipath dynamics.

The goal of maintaining coherence between procedures is primarily relevant when the system attempts to observe phase evolution over time (e.g., for velocity estimation). In those cases, the update rate must be fast enough that phase rotation due to Doppler between successive measurements remains within a manageable fraction of 2\pi e.g., no more than ~30-45° (π/6 to π/4 radians)—to avoid ambiguity and enable robust tracking.

It is noted that more frequent updates between procedures allow the system to more accurately track motion over time, enabling estimation of velocity and acceleration by comparing position estimates across successive ranging operations. This higher-level temporal resolution improves system responsiveness and contextual awareness (e.g., distinguishing walking from standing still).

With respect to phase drift, it is noted that phase itself does not inherently “drift” between procedures in the traditional sense, particularly if each procedure is processed independently. However, in configurations where the system attempts to leverage Doppler-based processing techniques such as estimating relative velocity from phase changes across multiple procedures coherence between procedures becomes important. In these cases, motion-induced changes in phase, Doppler shifts, or environmental dynamics (e.g., multipath changes) may introduce discontinuities between procedures if the time between them is too long. This may degrade the effectiveness of such Doppler-based techniques or lead to unstable estimates.

### D. Reducing System Latency

The system 100 may be configured to reduce latency in phase-based ranging, particularly in fast-moving environments where delays between measurements cause phase errors to accumulate. Enhancing or optimizing the signal processing pipeline may facilitate reducing or minimizing this delay. By enhancing algorithm efficiency and employing real-time processing techniques, such as parallel processing or dedicated hardware (e.g., DSPs or FPGAs), the system 100 may significantly reduce the time it takes to process phase data. This may ensure that phase measurements are current and accurately represent the position of the device, reducing the potential for outdated data leading to erroneous range estimates.

Additionally, predictive filtering algorithms, such as Kalman filters, may be used to estimate the position of the device between phase measurements. These algorithms may account for the velocity of the device and motion trajectory, helping to bridge the gap created by slower update rates. By incorporating predictive models, the system may maintain a more accurate estimate of the position of the device even when latency is moderate, improving overall ranging precision and reducing the impact of motion-induced errors.

### E. Summary of Phase Error Mitigation Strategies

A variety of mitigation strategies may be implemented by the system to enhance accuracy as described herein, including one or more of the following:
Multipath Mitigation: Use of multiple antennas (MIMO), RAKE receivers or RAKE-like multipath combining algorithm, and multipath suppression techniques to isolate the direct path signal, or a combination thereof. Additionally, or alternatively, time-of-flight measurements and environment-aware algorithms may further reduce multipath errors.
Handling Phase Wrapping: Increase the sampling rate, apply unwrapping algorithms, and use smoothing filters to prevent unwrapping errors caused by motion, or a combination thereof.
Doppler Shift Compensation: Estimate and compensate for Doppler shift due to motion, and ensure frequent phase updates to reduce drift.
System Latency: Reduce latency by enhancing or optimizing the processing pipeline and using predictive filtering to estimate device positions between updates.

### VI. Sensor Fusion Approach

Phase-based ranging can be prone to reliability concerns in complex environments, where multipath effects and noise distort the signal. However, integrating outputs from different sources can enhance system robustness. For instance, integrating amplitude-based measurements, such as RSSI or signal strength, alongside phase data can improve system robustness.

In one embodiment, a phase-amplitude fusion approach can combine the fine-grained accuracy of phase differences with the more stable characteristics of amplitude data. Amplitude is generally less affected by multipath but often less precise, while phase measurements provide more precise range information. A fusion algorithm, whether simple weighted averaging or more sophisticated machine learning models, may help blend multiple data sources to enhance the reliability of the range estimate. The result is a more resilient system that maintains accuracy in environments where phase data alone is likely to be insufficient.

In environments characterized by high reflectivity, such as parking lots filled with vehicles, leveraging environment-aware algorithms can further mitigate the impact of multipath. For instance, by employing mapping or machine learning techniques, the system 100 may be configured to model the reflective properties of the environment. This approach may enable the system to dynamically adjust ranging estimates by learning and recognizing the common patterns of signal reflection. The system may be configured to downweight or discard signals likely to be reflections, allowing the direct path to be more reliably detected and used for range estimation. This approach may enhance the accuracy of the ranging process in challenging environments.

In environments characterized by high reflectivity, such as parking lots filled with vehicles or indoor spaces with many reflective surfaces, leveraging environment-aware algorithms may further mitigate the impact of multipath. For example, the system 100 may employ mapping techniques, such as creating a spatial model or fingerprint of the RF environment based on known antenna positions and previously measured signal characteristics (e.g., phase, RSSI, time-of-flight), to infer where strong reflectors or persistent multipath sources are located.

Alternatively, or in combination, the system 100 may use machine learning techniques (e.g., supervised or unsupervised models) trained on prior data collected in similar environments to learn statistical patterns in the signal characteristics that are indicative of non-line-of-sight (NLOS) or reflected paths. These models may associate signal patterns—such as excessive delay, erratic phase evolution, or sudden drops in signal strength—with reflection or obstruction events. By doing so, the system 100 can dynamically adjust the weighting of candidate range estimates—for example, downweighting or excluding channels or antenna paths that are likely corrupted by multipath—and prioritize those consistent with a direct path.

This modeling may be static (based on pre-learned maps of specific known environments) or adaptive (continuously updated during operation as new signal data is acquired). In both cases, these techniques aim to improve the ability of the system 100 to isolate and trust the most reliable signals for range estimation.

In addition to comparing phase differences across spatially diverse antennas to detect and mitigate multipath, the system 100 may also leverage amplitude (e.g., RSSI or channel magnitude) variations across antennas as an indicator of multipath interference. Because multipath can cause constructive and destructive interference that manifests as amplitude peaks and fades, comparing the channel response magnitudes across antennas may reveal spatial nulls and signal inconsistencies characteristic of reflection-dominated channels. These amplitude-based observations may be correlated with phase anomalies or inconsistencies in round-trip time (RTT) estimates to improve the reliability of multipath detection. In one embodiment, the system may construct per-antenna channel maps and apply pattern recognition or thresholding techniques to identify frequency channels that are likely affected by multipath. These affected channels may then be downweighted, filtered, or excluded from final range estimation, whether it is derived from phase, amplitude, or time-of-flight metrics. This cross-domain fusion of spatial and frequency information enhances the robustness of ranging in complex, reflective environments.

In one embodiment, the system 100 may increase the frequency of executed channel-sounding procedures to reduce the impact of rapid motion between the transmitting and receiving devices. This increase in channel-sounding rate may enable the system 100 to more closely track dynamic changes in range, mitigating errors due to motion-induced phase changes or missed intermediate positions. In addition to adjusting the procedure frequency, the system 100 may be configured to modify the composition of individual procedures themselves—for example, by increasing or decreasing the number of frequency channels used, adjusting the number of round-trip time (RTT) packets included, or controlling the repetition of measurements. These modifications may enable the system 100 to balance latency, robustness, and accuracy depending on the application context. A higher procedure rate with appropriately tuned parameters may improve the temporal resolution of phase and time-of-flight measurements, helping the system 100 respond more effectively to rapid device movement and reducing errors due to phase wrapping, fading, or abrupt channel transitions.

In one embodiment, for even greater precision, directional antennas or beamforming techniques may be employed to mitigate the effects of reflections. By focusing the signal on the direct path and reducing the impact of off-angle reflections, this approach may help to isolate the line-of-sight signal, thereby enhancing accuracy in multipath-heavy scenarios. In combination with phase-amplitude fusion, beamforming may further bolster robustness against noise and multipath distortions.

In one embodiment, combining phase, amplitude, and additional signal processing techniques like time-of-flight, or a combination thereof, may allow for more accurate and reliable range estimation in complex environments-see e.g., the fusion-based system depicted in FIG. 8 with the phase-based processor 310-1, amplitude-based processor 310-2, and the time-of-flight-based processor 310-3. Each data source may have unique strengths and weaknesses, and fusing them together through advanced algorithms enables the system to overcome the limitations of any single method, improving overall performance in difficult, reflective settings such as parking lots.

To take advantages of the strengths and mitigate the weaknesses of the various types of channel-sounding measurements, one embodiment according to the present disclosure may include a sensor fusion processor 420 that combines phase, amplitude (RSSI), and time-of-flight measurements, or one or more other sources, or a combination thereof, to enhance the accuracy of range estimation in challenging environments. Phase offers high precision but is susceptible to multipath interference and ambiguity due to wrapping, while amplitude provides coarse distance estimates influenced by environmental factors, and time-of-flight offers direct range measurements but can suffer from multipath delays. By using a weighted fusion approach and employing a Kalman filter, the sensor fusion algorithm may dynamically adjust to the reliability of each modality, compensating for their individual weaknesses. Pre-processing steps such as phase unwrapping, amplitude normalization, and time-of-flight filtering may refine the data before fusion, while the Kalman filter may predict and updates range estimates, incorporating velocity information when necessary. Outlier rejection may further ensure that reliable data informs the final range estimate. This approach may result in a more robust and accurate ranging system, particularly with respect to environments with noise and interference.

In one embodiment, the sensor fusion processor 420 may use a weighted combination of phase, amplitude, and time-of-flight measurements, filtered by a Kalman filter to mitigate noise and measurement errors. This approach may fuse the strengths of each modality while compensating for their individual weaknesses.

### A. Outline of Sensor Fusion Algorithm

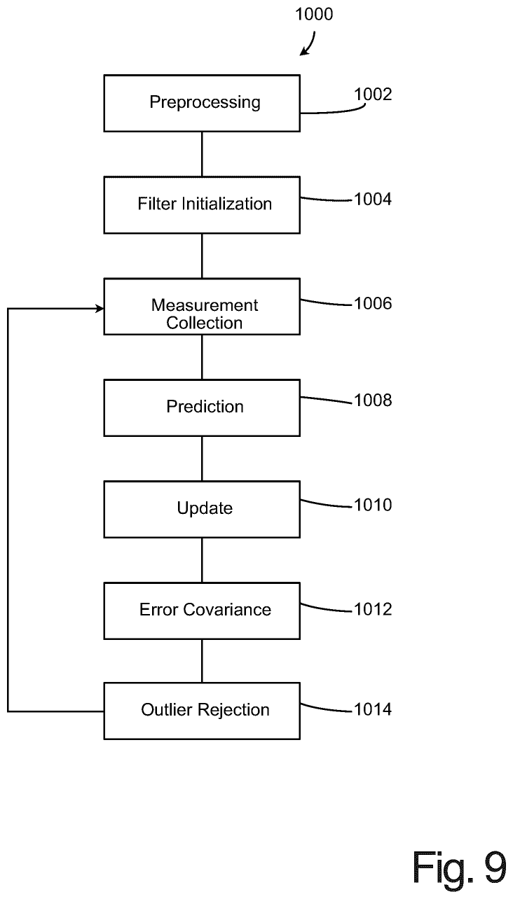

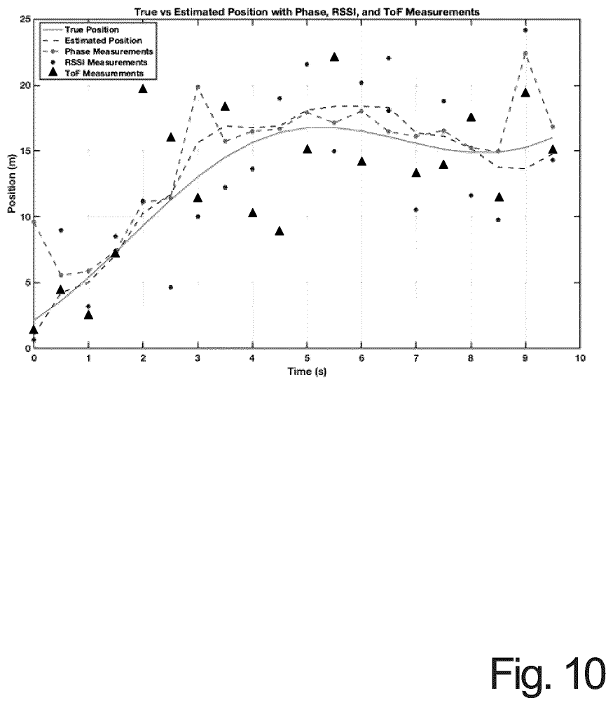

The sensor fusion processor 420 may be configured to operate according to one embodiment shown in FIG. 9 and generally designated 1000. The method 1000 may include one or more of the identified steps or variants thereof.

The method 1000 may include one or more pre-processing steps. Step 1002. These pre-processing aspects may vary depending on the application. In one embodiment, the pre-processing aspects may include phase unwrapping—e.g., to correct for phase wrapping by analyzing the difference between phase measurements across channels or over time. The pre-processing steps may include amplitude normalization—e.g., normalizing the RSSI values to account for path loss and fading. This amplitude normalization may involve smoothing or filtering the amplitude data to reduce the effect of fast fading. The pre-processing steps may include time-of-flight filtering—e.g., using initial rough range estimates from time-of-flight, applying low-pass filtering to remove outliers caused by multipath or clock synchronization issues.

The method 1000 may include filter initialization (e.g., Kalman filter initialization) steps. Step 1004. A state vector may be provided and defined as xₖ [rₖ,\dot{r}ₖ], where rₖ is the estimated range at time step k, and \dot{r}ₖ is the rate of change of range (i.e., velocity). This approach may be helpful in mitigating errors if the target device is in motion. A measurement vector may also be provided and defined as zₖ=[rₚₕₐₛₑ,r_{amplitude},r_{ToF}], where rₚₕₐₛₑ is the range estimate from phase, r_{amplitude} is the range estimate from amplitude (RSSI), and r_{ToF} is the range estimate from time-of-flight.

It is noted that RSSI, in and of itself, is not a direct measure of distance. It is a signal characteristic, much like phase and time-of-flight, that may be used to estimate range when interpreted through an appropriate model. In defining a measurement vector that includes r_phase, r_amplitude, and r_ToF, each of these modalities may be defined to provide an independent signal-derived estimate of range—not a literal measurement, but an inferred distance based on signal characteristics and assumptions about the propagation environment.

Just as time-of-flight may involve assumptions about synchronization and signal travel time, and phase-based ranging may involve unwrapping and frequency model assumptions, amplitude-based (RSSI) estimates may involve a path loss model. While traditional RSSI-based ranging may have limitations—such as high variability across devices and environments—it is included here not as a sole source of range, but as an auxiliary input to the fusion algorithm. When normalized or modeled (e.g., via logarithmic path loss, fading correction, or CS-specific magnitude analysis), RSSI-based ranging may provide coarse but useful information that reinforces or bounds the more precise phase and time-of-flight estimates.

In one embodiment, r_amplitude may be derived not from generic packet-level RSSI (e.g., CNF or MO RSSI), but rather from channel-sounding (CS) magnitude information, which may be more stable across devices due to the standardized and deterministic structure of CS procedures. That said, the system 100 may also consider using device-specific calibration or dynamic model fitting to account for hardware variation, depending on application needs.

Ultimately, the fusion framework may be configured not to rely solely on amplitude data, but to allow its inclusion in a way that complements the other modalities. Each source may contribute according to its confidence or reliability in a given context, and the Kalman filter (or other fusion engine) may manage the weighting adaptively.

The filter initialization process may include conducting an initial estimate—e.g., initializing the range and velocity estimates, for example, based on early time-of-flight measurements.

The method 1000 may include providing at least one measurement models. Step 1006. One measurement model that may be provided includes a phase-based ranging model, which can be defined as follows:

$${r}_{phase} = \frac{c Δ φ}{4 π Δ f} ,$$

where Δφ is the unwrapped phase difference over the channel spacing Δf. This phase-based ranging model may provide an estimate of the range modulo the maximum unambiguous range,

$$\frac{c}{2 Δ f}$$

or approximately 150 m for Bluetooth channel sounding. It is to be understood that the present disclosure is not limited to this model for phase-based ranging, and that there are many ways to estimate this range, each with their own advantages and disadvantages. In general, the types of range estimation algorithms for phase-based ranging can include, but are not limited to, Fourier-based techniques such as the non-uniform Fourier transform (nuFFT) and the fast Fourier transform (FFT), pseudospectrum techniques such as MUltiple Signal Classification (MUSIC), and Estimation of Signal Parameters via Rotational Invariant Techniques (ESPRIT), and a combination thereof.

One measurement model that may be provided includes amplitude-based ranging, which can be defined as follows:

$${r}_{amplitude} = {α ( \frac{{P}_{t}}{{P}_{r}} )}^{1 / n}$$

where α is a constant, Pₜ is the transmitted power, Pᵣ is the received power (RSSI), and n is the path-loss exponent (typically between 2 and 4 depending on the environment). It is to be understood that the present disclosure is not limited to this particular definition for the amplitude-based model and that any type of amplitude based ranging model may be utilized.

One measurement model that may be provided includes time-of-flight based ranging, which can be defined as follows:

$${r}_{ToF} = \frac{c \cdot {t}_{ToF}}{2}$$

where c is the speed of light and t_{ToF} is the measured time-of-flight.

The method 1000 may include providing one or more predictions, which may involve a filter (e.g., a Kalman filter). Step 1008.

In the prediction step 1008, the filter (e.g., a Kalman filter) may project the current state of the system into the future, estimating what the next state will be. This is based on the model of the system, which describes how the state evolves over time. The predicted state is calculated using the previous state and any control inputs (if applicable). Along with the predicted state, the filter may also estimate how uncertain this prediction is by increasing the error covariance. This prediction step 4 may make a guess about the future state of the system before any new data is received.

The method 1000 may include providing one or more updates, which may involve a filter (e.g., a Kalman filter). Step 1010.

In the update step 1010, the filter (e.g., a Kalman filter) may refine its prediction by incorporating new measurements. The filter may compare the predicted state to the actual measurement and calculate the difference (described as the “innovation” or “residual”). The filter may then adjust the predicted state by weighting the innovation based on how confident it is in the measurements and the model. The filter gain (e.g., the Kalman gain), a value determined by the relative uncertainties of the model and the measurement, may control how much the prediction is adjusted. After this correction, the filter may also update the error covariance to reflect the improved estimate.

The method 1000 may include providing one or more updates for error covariance, which may involve a filter such as a Kalman filter. Step 1012.

The error covariance matrix may be a measure of how uncertain the system is about its state estimates. The matrix may account for uncertainties in both the system model (e.g., how well the model captures the dynamics) and the measurement noise (e.g., inaccuracies in sensor readings). The matrix may be used to determine the filter gain (e.g., the Kalman gain), which dictates how much weight the filter places on new measurements versus the prediction from the model. The higher the uncertainty, the more the filter relies on new measurements, and vice versa.

The method 1000 may include providing outlier rejection. Step 1014. Use of statistical techniques may be provided to reject outliers in the measurements caused by severe multipath or noise. This may help to ensure that reliable measurements are fed into the filter (e.g., the Kalman filter). Several techniques are available for outlier rejection in sensor fusion algorithms, each with its own strengths and limitations.

One method for outlier rejection includes thresholding, where predefined limits are set to discard measurements that fall outside an expected range. For example, if a time-of-flight measurement suggests an implausibly large distance, it can be discarded as an outlier. Similarly, phase and received signal strength indicator (RSSI) measurements can be rejected if they deviate significantly from predicted values. Thresholding can be computationally efficient but may be too restrictive, potentially rejecting valid measurements or too lenient, allowing outliers to slip through.

An additional or alternative method for outlier rejection may involve using the Mahalanobis distance, which is a statistical measure that evaluates how far a new measurement deviates from the expected distribution of past measurements. This method may calculate the distance between the new measurement and the predicted state in terms of standard deviations, taking into account the covariance of the data. Mahalanobis distance may offer an adaptive approach, as it considers the uncertainty in both the measurement and the predicted state, but it may involve the computation of covariance matrices, which can be computationally intensive, particularly in real-time systems.

Yet another additional or alternative method for outlier rejection may include residual analysis, which can be used in conjunction with Kalman filtering and sensor fusion. The residual may be the difference between the predicted measurement, based on the current state estimate, and the actual measurement. If the residual is larger than expected, it indicates that the measurement is far from what the model predicted, flagging it as an outlier. This method is particularly useful in dynamic systems where the state is continuously evolving. However, selection of the rejection threshold can significantly affect effectiveness, and so the rejection threshold may be selected to avoid filtering out valid but noisy measurements.

Further another additional or alternative method of outlier rejection may include consistency checks across different modalities to provide another layer of robustness in sensor fusion systems. For instance, system that fuses data from phase, amplitude, and time-of-flight measurements can identify outliers by comparing the consistency across these modalities. If the phase-based range estimate differs significantly from both the amplitude and time-of-flight estimates, it may suggest unreliable phase data, which can then be downweighted or discarded. This method may leverage the complementary strengths of multiple sensors but may involve balancing of the weight assigned to each modality.

Yet further another additional or alternative method of outlier rejection may include a machine learning-based approach, which may offer a powerful way of detecting outliers by learning patterns from past data. Neural networks or anomaly detection algorithms can flag unusual patterns that indicate unreliable measurements, making this approach particularly useful in complex environments, such as urban areas or parking lots, where multipath interference can introduce non-linear distortions. While machine learning models can often handle these intricate scenarios better than traditional statistical techniques, machine learning models involve extensive training data and computational resources, making them less practical for some real-time applications without further optimization.

### B. Sensor Fusion Methodology

The method 1000 according to one embodiment may provide a framework for improving the accuracy and reliability of range estimation in environments where traditional phase-based ranging systems encounter significant challenges. By integrating phase, amplitude (RSSI), and time-of-flight measurements into a single estimation framework, the algorithm may leverage the complementary strengths of each modality while reducing or minimizing the limitations inherent in their individual use.

Phase-based ranging, while highly precise due to its fine granularity, may suffer from significant limitations in real-world environments. Chief among these is phase ambiguity due to wrapping and sensitivity to multipath interference, both of which can lead to erroneous distance estimates. In complex environments—such as parking lots, where reflective surfaces like vehicles and walls create strong multipath components—the direct path signal may involve significant effort to isolate. The method 1000 and variants thereof according to one embodiment may address these limitations by using advanced phase unwrapping techniques and applying smoothing filters to mitigate noise and phase wrapping errors. The integration of phase data into a fusion framework may allow it to be used in concert with more resilient data types, compensating for the inherent weaknesses of phase-based ranging.

Amplitude measurements, commonly represented as Received Signal Strength Indicator (RSSI), may provide a coarse but reliable estimate of distance based on signal attenuation. Although RSSI may be sensitive to environmental factors such as interference and fading, it is less prone to multipath effects compared to phase measurements. The method 1000 may capitalize on this relative robustness by normalizing and filtering RSSI values to smooth out fast fading and inconsistencies. However, amplitude-based ranging follows an inverse-square law of distance estimation, which tends to degrade accuracy over longer distances. When used alone, RSSI offers limited precision, but when fused with phase and time-of-flight data according to one embodiment, amplitude measurements such as RSSI may add an additional layer of resilience to the overall range estimation process, particularly in noisy or multipath-heavy environments.

It is noted that RSSI alone is not considered reliable in an absolute sense across all conditions, and one limitation of RSSI includes that its value for range estimation is highly dependent on device orientation, occlusion (e.g., back pocket vs. front pocket), antenna polarization mismatch, and environmental factors. In this context, reliability with respect to RSSI is meant to be relative to phase measurements in certain multipath scenarios—where phase can be significantly corrupted or ambiguous due to wrapping, interference, or motion—whereas RSSI, despite being coarse and device-dependent, tends to vary more slowly and may provide gross proximity cues even when phase fails.

RSSI may provide a coarse but relatively stable estimate of proximity in some scenarios, particularly when phase measurements are compromised by multipath or phase ambiguity.

Additionally, it is noted that calibrating one modality against another may be implemented according to one or more embodiments described herein. This cross-modality calibration—wherein coarse RSSI data may be corrected or interpreted in light of more precise but fragile phase-based ranging (PBR) or round-trip time (RTT) measurements—may be a useful technique to help stabilize the amplitude-based estimates or other types of estimates over time and across devices. The fusion system may include a learning or calibration mechanism according to one embodiment that aligns amplitude-derived estimates with those derived from phase or time-of-flight when the latter are deemed trustworthy-indeed any estimate from one modality (e.g., RSSI or signal strength) may be aligned or calibrated with an estimate or estimates from one or more other modalities (e.g., phase or time-of-flight).

For instance, the system may opportunistically update its amplitude-distance mapping based on ground-truth-quality range estimates (e.g., when multipath is minimal and PBR confidence is high), thus adapting its model over time to compensate for device-specific or environmental variability.

Time-of-flight may provide the most direct range estimate by measuring the time delay between signal transmission and reception. In theory, time-of-flight offers a straightforward and accurate calculation of distance. However, in practice, time-of-flight measurements are considered vulnerable to clock synchronization errors and multipath propagation, where reflected signals can delay the perceived arrival time, skewing the distance estimate. The fusion algorithm according to the method 1000 may help to address these issues by applying a low-pass filter to time-of-flight measurements, removing spurious results caused by clock drift or multipath reflections. Time-of-flight measurements may then be combined or analyzed in conjunction with phase and amplitude estimates to provide a more holistic range estimate that balances direct distance measurements with the robustness of phase and RSSI data.

The phrase delay the perceived arrival time is not be construed in a narrow sense. In the presence of multipath, reflected signals can alter the perceived arrival time in either direction, depending on which path is dominant or misidentified as the line-of-sight (LOS) component. While the first arriving signal is often considered the LOS path, some systems may lock onto a stronger reflected signal that arrives slightly later, effectively delaying the time-of-flight estimate. In other cases, constructive interference or improper signal detection may cause an apparent advancement, leading to underestimated distances.

In one embodiment, cross-modality correlation between RTT, PBR, and RSSI may be a practical and powerful technique for improving robustness, particularly in noisy or multipath-heavy environments. Each of these modalities has different error modes: for instance, RTT can be affected by clock skew or reflection-induced delays, PBR can struggle with phase ambiguity or wrapping, and RSSI can be impacted by device orientation or body shadowing. However, when one measurement appears inconsistent with the others for example, a large RTT value that is not supported by corresponding PBR or RSSI data that outlier may be flagged and downweighted or rejected entirely.

This correlation-based outlier rejection may be implemented as part of the sensor fusion pipeline, either via rule-based logic (e.g., bounded residual thresholds between modalities) or as part of a probabilistic filter (e.g., Kalman or particle filter), which dynamically adapts measurement confidence based on cross-checks. One embodiment of the present disclosure, including the method 1000, may be adapted for such filtering or outlier rejection.

In one embodiment, a filter (e.g., a Kalman filter) serves as the central element in sensor fusion approach, dynamically weighting the contributions of each modality based on their relative reliability in any given situation. The filter is described in several embodiments as a Kalman filter-however, the present disclosure is not so limited. Any type of combiner or filter may be utilized in conjunction with the sensor fusion approach described herein.

In one embodiment, a sensor fusion processor may be configured to dynamically weight phase, amplitude, and ToF data, and the system may employ spatially diverse antennas with different polarizations. The connection between the polarization characteristics and how they are used in the signal processing—particularly within the machine learning system or sensor fusion processor—may vary from application to application.

Polarization diversity may be leveraged as a factor in how measurements are weighted, filtered, or selected (e.g., assigning more weight to signals received on polarizations that show higher SNR or lower phase distortion). The system may use polarized antennas and/or also incorporate their polarization-specific characteristics in the data fusion process, such as by dynamically adjusting weights or rejecting unreliable signals based on polarization-dependent performance. This can help strengthen the protection of that aspect and avoid ambiguity as to whether polarization diversity is merely part of the hardware configuration or an integral part of the signal processing strategy.

In one embodiment, by defining a state vector that includes both range and velocity, the method 1000 can track not only the current distance but also the rate of change in distance, making it particularly effective in scenarios where the target device is in motion. The Kalman filter's prediction step 4 may estimate the next state based on the current motion model, while the update step 5 may correct this estimate using new measurements from phase, amplitude, and ToF. This recursive process may ensure that the system is constantly refining its range estimates, reducing the likelihood of accumulating errors over time.

One advantage of the Kalman filter is its ability to adapt to changing conditions by adjusting the Kalman gain. This allows the algorithm of the method 1000 to dynamically assign more weight to the most reliable measurement modality at any given moment, whether it is phase, RSSI, or ToF. For example, in situations where phase data is unreliable due to heavy multipath interference, the algorithm can shift weight towards ToF or amplitude data, preventing large errors from phase wrapping or multipath reflections from corrupting the final estimate.

In addition to leveraging sensor fusion to combine phase-based ranging (PBR), received signal strength indicator (RSSI), and round-trip time (RTT) data, the Kalman filter—or more generally, any filter or estimator used in the system—may also benefit from dynamic or adaptive weighting based on contextual information such as coarse position classification. For example, determining whether the remote device is near the driver side, passenger side, front, or rear of the vehicle can provide valuable situational context that informs the reliability of each ranging modality. In scenarios where multipath is expected to be more severe—such as near vehicle panels or glass surfaces-phase-based ranging may be dynamically down-weighted in favor of more stable modalities like RTT or RSSI. Conversely, in open zones with lower reflection profiles, phase-based estimates may be weighted more heavily due to their superior precision. Incorporating this coarse spatial context into the fusion algorithm allows the system to intelligently adapt its measurement weighting strategy in real time, improving overall robustness and localization accuracy.

Multipath interference and motion-induced errors are two of the most significant sources of inaccuracy in phase-based ranging systems. In a dynamic environment, where the position of objects or the device itself may be changing, multipath effects can cause large fluctuations in phase measurements, leading to phase noise and incorrect distance estimates. The sensor fusion algorithm of the method 1000 may mitigate these effects by fusing phase data with complementary modalities, e.g., amplitude and ToF measurements, that are less prone to these effects. Additionally, outlier rejection techniques, such as the Mahalanobis distance, may be employed to discard measurements that are significantly distorted by multipath or other environmental factors. This may ensure that reliable data is incorporated into the Kalman filter's state estimation.

To reject tone outliers caused by motion-induced distortion or multipath interference, the system 100 may implement a tone quality-based filtering algorithm. Each tone in a multitone Bluetooth channel sounding sequence may be evaluated for its consistency and reliability based on metrics such as signal-to-noise ratio (SNR), tone quality indicator (TQI), or coherence between initial and reflected signal paths. In one embodiment, the system 100 may compute a per-tone tone quality score derived from amplitude consistency, phase stability across adjacent tones, or cross-correlation between transmit and receive IQ samples. Tones that fall below a defined quality threshold-either statically set or dynamically adapted based on environmental or motion context—are flagged as outliers and excluded from the phase-based range estimation.

In a refined approach, the algorithm may maintain a moving window of tone quality values across recent observations. This may enable statistical outlier detection techniques, such as using the mean absolute deviation (MAD) or a Mahalanobis distance test, to identify tones with anomalous behavior. Additionally, spatial or frequency domain smoothing can be applied to detect isolated tone anomalies versus systemic degradation. When sufficient redundancy exists in the number of frequency channels, these lower-quality tones may be masked or downweighted in the final range computation, improving robustness against Doppler shifts, multipath artifacts, and transient environmental changes. The result may be a cleaner set of high-confidence tones used for unwrapping phase and computing accurate range estimates.

It is noted that amplitude and ToF measurements exhibit different sensitivities to environmental conditions and therefore offer complementary characteristics to phase measurements. While phase can offer high resolution, it is particularly vulnerable to wrapping and multipath distortion. Amplitude (e.g., RSSI) and ToF may be less susceptible to certain types of interference (e.g., ToF may better tolerate rapid phase shifts; amplitude may be less sensitive to narrowband fading), but they each have their own limitations such as amplitude being influenced by device orientation or polarization mismatch, and ToF being vulnerable to synchronization drift and long-path reflections.

The fusion algorithm in the method 1000 according to one embodiment leverages these differences by combining modalities whose error modes do not fully correlate. This way, when one modality is compromised, others can provide a corrective influence, or the combination of diverse modalities with complementary failure characteristics strengthens robustness and helps reject distorted measurements.

The ability of the system to handle motion may be enhanced by the inclusion of velocity as part of the state vector in the Kalman filter. In fast-moving scenarios, where the relative velocity between devices introduces Doppler shifts and rapid changes in phase, the system can use predictive algorithms to estimate the position of the device between phase measurements, thereby maintaining a more accurate range estimate. This predictive capability is particularly helpful in environments where the update rate is limited by system latency, allowing the algorithm to “bridge the gap” between successive measurements.

In environments characterized by high levels of interference, reflection, and dynamic motion—such as parking lots or industrial settings—the sensor fusion algorithm according to one embodiment may be configured to maintain robustness. The combination of phase, amplitude, and ToF measurements, filtered through a Kalman framework and supported by outlier rejection, may enable the system to adapt to complex environmental conditions without a significant loss of accuracy. By fusing multiple sources of data, the algorithm may ensure that errors from any one modality are mitigated by the strengths of the others, resulting in a more reliable overall range estimate. By fusing these three modalities (or other modalities or a combination of modalities), the overall system may become more robust and provide a more accurate range estimate, even in challenging environments with noise and interference.

The sensor fusion algorithm according to one embodiment of the method 1000 may combine phase, amplitude (RSSI), and ToF measurements to enhance the accuracy of range estimation in challenging environments. Phase may offer high precision but is susceptible to multipath interference and ambiguity due to wrapping, while amplitude may provide coarse distance estimates influenced by environmental factors, and ToF may offer direct range measurements but can suffer from multipath. By using a weighted fusion approach and employing a Kalman filter, the algorithm may dynamically adjust to the reliability of each modality, compensating for their individual weaknesses. Pre-processing steps such as phase unwrapping, amplitude normalization, and ToF filtering refine the data before fusion, while the Kalman filter predicts and updates range estimates, incorporating velocity information when necessary. Outlier rejection may further ensure that reliable data informs the final range estimate. This approach may result in a more robust and accurate ranging system, particularly in environments with noise and interference. Range estimations for the method 1000 according to one embodiment are shown in FIG. 10.

In other words, the sensor fusion approach may obtain outputs from multiple data sources or modalities, and generate determine a location estimation in a manner that relies on the strengths of each modality while reducing or minimizing effects in the modalities due to weaknesses in the modalities.

C. Expanding the Sensor Fusion Algorithm to Leverage Multiple Co-Located Antennas with Different Polarizations

The integration of multiple co-located antennas with distinct polarizations into a sensor fusion framework (e.g., a plurality of spatially diverse antennas with different polarization configurations, potentially co-located with each other) may provide yet another avenue for improving the accuracy and robustness of ranging and localization systems. By utilizing antennas 30 with different polarization characteristics, the system may exploit additional degrees of freedom in signal propagation, particularly in environments with multipath interference and varying channel conditions. The method 1000 or other algorithms described herein may be expanded so that sensor fusion can utilize multiple co-located antennas 30 with different polarizations.

In conventional wireless systems, a single antenna or set of antennas 30 with the same polarization may be employed for signal transmission and reception. However, signal behavior in complex environments is heavily influenced by polarization effects. For example, signals can reflect off surfaces, causing changes in polarization that lead to signal degradation when using a single-polarization antenna. By deploying antennas 30 with different polarizations (e.g., vertical, horizontal, and circular), the system can selectively receive the strongest, least distorted signals from each polarization, thereby mitigating the effects of multipath and improving the quality of the measurements.

Incorporating polarization diversity into the sensor fusion algorithm can improve both phase and amplitude measurements. Signals received on different polarizations may experience different levels of attenuation and phase shift due to environmental factors, such as reflections and scattering. The fusion of these measurements may enable the algorithm to weigh the most reliable signal from each polarization, improving the overall accuracy of distance estimation.

To effectively utilize multiple co-located antennas 30 with distinct polarizations, the sensor fusion algorithm may be expanded to process and combine data from each antenna independently. This may involve one or more of the following steps: independent measurement collection, cross-polarization calibration, enhanced measurement models, polarization-aware sensor fusion, and outlier rejection across polarization channels.

In one embodiment, each antenna 30 may receive phase, amplitude (RSSI), and possibly ToF measurements independently. Because the antennas 30 are co-located but polarized differently, the received signals may vary in their susceptibility to multipath and interference. The measurements from each antenna 30 may provide complementary information that can be combined to produce a more accurate range estimate.

To ensure that measurements from different polarizations can be meaningfully combined, the system 100 may be configured to account for the relative gains, phase offsets, and amplitude differences between the antennas. A cross-polarization calibration step may ensure that these differences are normalized before fusion. This calibration may involve determining the correlation between different polarization channels and adjusting the measurement models accordingly.

The measurement models for phase, amplitude, and ToF may be updated to account for the different signal behaviors experienced by each polarized antenna. For instance, phase measurements from a horizontally polarized antenna may experience greater multipath distortion in certain environments than those from a vertically polarized antenna. The fusion algorithm may use these models to weight each antenna's contribution to the overall estimate based on the current environment and signal quality.

The fusion approach described herein may be configured to dynamically fuse data from each antenna 30 (e.g., each antenna of antenna array 30 of a system device and/or each antenna from multiple system devices), adjusting the weight assigned to each signal based on its reliability. In this way, the outputs based on information from the antennas, although potentially based on the same or similar ranging models, may be different due to the difference in antenna configuration and characterized as different modalities for processing by the fusion algorithm.

In this expanded version of the sensor fusion algorithm, the combiner or filter (e.g., a Kalman filter) can incorporate measurements from multiple polarization channels. This involves creating a measurement vector that includes phase and amplitude data from each polarization and applying adaptive weighting based on the current signal-to-noise ratio (SNR) or other metrics that quantify the reliability of each signal. The Kalman gain can then be adjusted to reflect the confidence in each polarization channel, providing a robust estimate of the range.

The use of multiple polarization channels may also enhance outlier rejection capabilities. Measurements from one polarization channel may be highly corrupted by multipath or interference, while another polarization may provide a clean line-of-sight signal. The algorithm can detect inconsistencies across polarization channels and discard unreliable measurements. This cross-polarization consistency check is similar to cross-modality checks in a sensor fusion algorithm according to one embodiment described herein but takes advantage of polarization diversity to enhance robustness.

The inclusion of polarization diversity in the sensor fusion algorithm offers several benefits including improved robustness to multipath, enhanced signal strength and reliability, and mitigation of polarization mismatch. Different polarizations interact with surfaces and obstacles in distinct ways, leading to varying levels of multipath interference. By fusing data from multiple polarizations, the algorithm can downweigh or discard measurements that are heavily impacted by multipath, while relying more on the signals that remain relatively unaffected. This significantly improves the robustness of the system 100, particularly in complex environments such as urban areas or indoor spaces where reflections are prevalent.

Polarization diversity may increase the likelihood of receiving a strong, undistorted signal. In environments where a single polarization may suffer from fading or polarization mismatch, the other polarized antennas can still provide useful information. This redundancy may ensure that the system can maintain high accuracy even when some channels experience signal degradation.

In many real-world applications, the polarization of the transmitted signal may not align perfectly with the receiving antenna. This mismatch can result in significant signal loss. By employing multiple antennas with different polarizations, the system reduces the likelihood of severe polarization mismatch, ensuring more reliable signal reception.

While polarization diversity provides numerous advantages, it also introduces additional concerns to be addressed by the sensor fusion algorithm. One of the primary concerns is the increased computational complexity. Processing and fusing data from multiple antennas in real-time may involve additional computational resources, particularly when using advanced filtering techniques like Kalman filters. Efficient algorithm configuration and hardware acceleration may be useful to meet real-time processing requirements.

Additionally or alternatively, for a system 100 configured to polarization diversity, the system may be configured to account for the potential correlation between polarization channels. In certain environments, signals received on different polarizations may be partially correlated due to similar propagation paths. The fusion algorithm may be configured to handle this correlation to avoid overestimating the reliability of redundant information.

Additionally or alternatively, the system may be configured to provide accurate calibration of the polarization channels to ensure that the measurements can be effectively combined. Inaccuracies in the calibration process may introduce biases that reduce the overall accuracy of the system.

In one embodiment, the system may be configured to implement a sensor fusion algorithm may incorporate output from multiple co-located antennas with different polarizations. By leveraging polarization diversity, the system can mitigate the effects of multipath interference, improve signal reliability, and reduce the impact of polarization mismatch. While this approach can introduce additional complexity in terms of algorithm design and computational requirements, the benefits it provides make it useful for modern wireless ranging and localization systems.

The sensor fusion algorithm in one embodiment may offer a robust configuration for improving range accuracy in environments where phase-based ranging alone may struggle due to issues such as multipath interference, phase wrapping, and environmental noise. For instance, by integrating outputs from more than one modality, such as phase, amplitude (RSSI), and ToF measurements, the algorithm may be configured to leverage the strengths of each modality while compensating for their individual limitations. Phase measurements, for instance, provide fine-grained distance data but are prone to noise and ambiguity; amplitude offers a coarse but resilient estimate, particularly in noisy environments; and ToF provides direct range estimates but is affected by clock synchronization issues and multipath. The combination of multiple modalities, filtered (e.g., through a Kalman filter) for dynamic weighting and prediction, may ensure that the system can adapt in real time to changing conditions and motion.

The pre-processing steps of the system 100, including phase unwrapping, amplitude normalization, and ToF filtering, may enhance the accuracy of raw data, while the prediction and update mechanisms of the filter (e.g., Kalman filter) may provide continuous, reliable range estimates. Additionally, outlier rejection may ensure that significant errors from multipath or noise do not significantly compromise the performance of the system 100. These techniques, together with environment-aware enhancements, such as mapping or beamforming, may further mitigate multipath effects in complex settings like parking lots and other industrial, urban, or mobile contexts.

### VII. Kalman Filter-based Estimated Range

The Kalman Filter according to one embodiment may estimate observed and hidden variables based on uncertain measurements in time-series data. The Kalman Filter can be computationally inexpensive and relies on the current measurement input and the previous measurement state/covariance.

The Kalman Filter may be configured by its system state, measurement noise (R), and process noise (Q). For instance, the system state is [x, v, a] ([position, velocity, acceleration]). Position is an observed state, while velocity and acceleration are hidden states. Measurement noise is determined by the variance in range measurement. Process noise is determined by the uncertainty in system motion.

The Kalman filter may estimate recursively, and only the previous state estimate and current measurement may be necessary to compute the current state. The process may involve two steps in each measurement cycle, a prediction step and an update (measurement correction) step.

The equations used in each measurement cycle according to one embodiment are as follows:
(predict step)
1. Predict the state ahead

$${x}_{k}^{-} = {F}_{k} {x}_{k - 1}$$

2. Predict the state error covariance ahead

$${P}_{k}^{-} = {F}_{k} {P}_{k - 1} {F}_{k}^{T} + {Q}_{k}$$

(update step)
3. Calculate Kalman Gain

$${K}_{k} = {P}_{k}^{-} {{H}_{k}^{T} ( {H}_{k} {P}_{k}^{-} {H}_{k}^{T} + {R}_{k} )}^{- 1}$$

4. Update the state estimate

$${x}_{k} = {x}_{k}^{-} + {K}_{k} ( {z}_{k} - {H}_{k} {x}_{k}^{-} )$$

5. Update the state error covariance

$${P}_{k} = ( I - {K}_{k} {H}_{k} ) {P}_{k}^{-}$$

Variable definition and matrix size can be found in the following table:

| | | |
|---|---|---|
| x | state estimate | (n × 1) |
| P | state covariance estimate | (n × n) |
| F | state transition matrix | (n × n) |
| H | observation matrix | (m × n) |
| R | measurement noise covariance | (m × m) |
| Q | process noise covariance | (n × n) |
| K | Kalman gain | (n × m) |
| z | Measurement | (m × 1) |

In one embodiment, six 1-dimensional Kalman filters may be used to generate a new range estimate for each of the six anchors (e.g., object devise). The system may begin by defining the system model variables, which include the state transition matrix (F), observation matrix (H), process noise covariance (Q), and measurement noise covariance (R).

The system state may be defined using range, velocity, and acceleration of the anchor. While velocity and acceleration are not directly measured, these can be included as hidden states. Using velocity and acceleration as hidden states may improve filter response during changing motion compared to using range alone. These additional states also allow retrieval of velocity for future use cases. The state estimate vector may be modeled as:

$$x = [ \begin{matrix}range \\ vel \\ acc\end{matrix} ] or x = [ \begin{matrix}X \\ \dot{X} \\ \ddot{X}\end{matrix} ]$$

The state transition matrix is defined as:

$$F = [ \begin{matrix}1 & dt & 0.5 {dt}^{2} \\ 0 & 1 & dt \\ 0 & 0 & 1\end{matrix} ]$$

$$where$$

$$dt = \frac{1}{{frequency}_{SCM}} = {timestamp}_{current} - {timestamp}_{previous}$$

The observation matrix is defined as:

H=[1 0 0]

It is worth noting that velocity and acceleration observations are entered as 0, so that they can be used as hidden states.

The process noise covariance may be determined by the uncertainty in target motion. In the system, the target motion may be modeled based on human walking motion. Because this type of human motion can be unpredictable, a constant valued diagonal matrix may be used for the process noise covariance. This constant can be adjusted for best performance. A constant value of 0.01 may be used to perform best during real-world vehicle tests:

$$Q = [ \begin{matrix}0.01 & 0 & 0 & 0 & 0 & 0 \\ 0 & 0.01 & 0 & 0 & 0 & 0 \\ 0 & 0 & 0.01 & 0 & 0 & 0 \\ 0 & 0 & 0 & 0.01 & 0 & 0 \\ 0 & 0 & 0 & 0 & 0.01 & 0 \\ 0 & 0 & 0 & 0 & 0 & 0.01\end{matrix} ]$$

The measurement noise covariance is determined by the uncertainty of the measurement itself, which in this case is the uncertainty of anchor range measurement. The noise covariance can be found by processing measurements (determine standard deviation) while the mobile device position is held constant. The sigma found, or a percentage of it, may be used as the r value. The use of a dynamic measurement noise covariance, rather than a constant one, is described herein. In a system using a constant measurement noise covariance, an r value of 1.0 cm is considered to generally perform well, although the r may be chosen based on system standard deviation.

R=1.0

In addition to system model variables, initial system state estimate and state covariance may be passed to the Kalman filter. The initial state estimate, x₀, may correspond to the first measurement taken. The initial state covariance, P₀, may be chosen to be a diagonal matrix with a value of RMSE² (the regressor has RMSE≈100 cm, so 10,000 is used). Changing P₀ may have a negligible effect on performance.

$${P}_{0} = [ \begin{matrix}10000 & 0 & 0 & 0 & 0 & 0 \\ 0 & 10000 & 0 & 0 & 0 & 0 \\ 0 & 0 & 10000 & 0 & 0 & 0 \\ 0 & 0 & 0 & 10000 & 0 & 0 \\ 0 & 0 & 0 & 0 & 10000 & 0 \\ 0 & 0 & 0 & 0 & 0 & 10000\end{matrix} ]$$

The Kalman filter can be modified to handle outliers through its measurement noise covariance. For instance, the Kalman filter may be configured to use a dynamically changing measurement noise covariance, rather than a constant one typically used for sensors. The measurement noise covariance may be determined by a function of the measurement variance and MAD (Mean Absolute Deviation) at each update step. A window size (e.g., an optimal window size) for variance may be determined through testing. By assigning higher uncertainty to select measurements, outliers may be removed without compromising the bulk of the filtered signal.

The measurement noise covariance, R, is a measure of uncertainty in sensor observations. Higher uncertainty in a measurement (a larger R value) may cause the filter to place less weight on the measurements when producing new estimates. Kalman filter implementations may use a fixed R, determined by the characteristics of the sensor. The uncertainty in BLE CS measurements can change depending on the user position and movements, if there is multipath, etc. It can be beneficial to use a changing R value in the Kalman filter. By setting a higher uncertainty (larger R value) when outliers are detected, the outliers can be reduced by the Kalman filter itself. To take it a step further, the measurement noise covariance R will be determined by some function of the measurement variance.

This function starts with a rolling window of size n of the previous anchor range measurements.

window=[Last n range measurements]

At each time step, the window may be updated with the latest measurement (+pop the oldest), and the variance of the window may be calculated.

$$variance = \frac{\sum {( window - {μ}_{window} )}^{2}}{n}$$

The function to determine R may rely on the variance of the rolling window. It also may include a scaling factor and base smoothing factor. The purpose of the base smoothing factor may be to provide a small level of uncertainty for signal filtering, even when variance is small.

$$R = ( \frac{1}{scale} ) * variance + smoothing factor$$

For an BLE CS 6-anchor system according to one embodiment, results were achieved with the following values:
n=5
scale=1000
smoothing factor=2

Directional terms, such as “vertical,” “horizontal,” “top,” “bottom,” “upper,” “lower,” “inner,” “inwardly,” “outer” and “outwardly,” are used to assist in describing embodiments and aspects of the present disclosure based on the orientation of the embodiments and aspects shown in the illustrations. The use of directional terms should not be interpreted to limit embodiments or aspects to any specific orientation(s).

The above description is that of current embodiments and aspects of the disclosure. Various alterations and changes can be made without departing from the spirit and broader aspects of the disclosure as defined in the appended claims, which are to be interpreted in accordance with the principles of patent law including the doctrine of equivalents. This disclosure is presented for illustrative purposes and should not be interpreted as an exhaustive description of all embodiments or aspects of the disclosure or to limit the scope of the claims to the specific elements illustrated or described in connection with these embodiments or aspects. For example, and without limitation, any individual element(s) of the described embodiments or aspects may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments and aspects include a plurality of features that are described in concert and that might cooperatively provide a collection of benefits. The present disclosure is not limited to only those embodiments or aspects that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z; and Y, Z.

While several forms have been shown and described, other changes and modifications will be appreciated by those skilled in the relevant art. Therefore, it will be understood that the embodiments shown in the drawings and described above are merely for illustrative purposes, and are not intended to limit the scope of the disclosure which is defined by the claims which follow as interpreted under the principles of patent law including the doctrine of equivalents.

The embodiments of the invention in which an exclusive property or privilege is claimed are defined as follows:

1. A method for improving the accuracy of phase-based ranging between two devices in dynamic environments, the two devices including a transmitting device and a receiving device, the method comprising:
a) receiving one or more radio frequency (RF) signals at the receiving device from the transmitting device;
b) extracting phase and amplitude information from multiple frequency channels of the received one or more RF signals;
c) compensating for Doppler shift caused by relative motion between the two devices by adjusting the phase information;
d) reducing phase unwrapping errors by increasing a frequency of ranging updates; and
e) estimating a range between the transmitting and receiving devices based on phase, amplitude, and time-of-flight information from the received one or more RF signals.

2. The method of claim 1, further comprising applying a Kalman filter to smooth phase measurements and reduce effects of noise and rapid phase changes caused by motion.

3. The method of claim 1, wherein reducing the phase unwrapping errors includes detecting phase wrapping based on amplitude variations across the multiple frequency channels of the received one or more RF signals.

4. The method of claim 1, wherein compensating for the Doppler shift includes using tone quality information to filter outliers caused by motion and interference.

5. The method of claim 1, further comprising detecting and mitigating multipath interference by comparing phase differences across spatially diverse antennas.

6. The method of claim 5, further comprising:
detecting amplitude anomalies across spatially diverse antennas by analyzing channel magnitude variations; and
correlating the anomalies with phase or time-of-flight inconsistencies to identify and mitigate multipath-affected channels during range estimation.

7. The method of claim 5, further comprising:
generating channel maps for each antenna path;
comparing said maps to identify frequency channels exhibiting fading or constructive interference; and
using this comparison to weight or exclude corresponding phase and time-of-flight measurements adversely affected by multipath.

8. The method of claim 1, wherein the ranging updates are increased by providing a higher channel-sounding rate to minimize the impact of rapid motion between the transmitting and receiving devices.

9. The method of claim 1, further comprising providing frequency diversity with respect to the one or more RF signals by averaging phase measurements across multiple subcarriers to reduce the impact of noise and fading.

10. A system for improving phase-based ranging accuracy between a transmitting device and a receiving device comprising:
a) a plurality of spatially diverse antennas with different polarization configurations at the receiving device;
b) a signal processor configured to receive one or more RF signals from the plurality of spatially diverse antennas, extract phase, amplitude, and time-of-flight data from the one or more RF signals across multiple frequency channels;
c) a sensor fusion processor configured to determine a range between the transmitting device and the receiving device based on the phase, amplitude, and time-of-flight data; and
d) a multipath mitigation processor configured to isolate direct path signals from multipath components based on data from the plurality of spatially diverse antennas.

11. The system of claim 10, wherein the plurality of spatially diverse antennas are co-located and configured with orthogonal polarizations to provide signal diversity in multipath-rich environments.

12. The system of claim 10, wherein the sensor fusion processor includes a machine learning system to dynamically weight phase, amplitude, and time-of-flight data.

13. The system of claim 12, wherein the machine learning system is configured to receive input indicative of a polarization characteristic of each of the plurality of spatially diverse antennas, and to dynamically adjust the weighting of phase, amplitude, and time-of-flight data based on the polarization characteristics to improve ranging accuracy in multipath environments.

14. The system of claim 10, further comprising a Doppler compensation processor that dynamically adjusts phase measurements based on an estimated velocity of the transmitting device.

15. The system of claim 10, wherein the multipath mitigation processor includes a ray tracing model to predict and filter out multipath signals.

16. The system of claim 10, wherein the signal processor includes an adaptive filter that adjusts in real-time based on an estimated level of multipath interference and a velocity of the transmitting device.

17. The system of claim 10, wherein the plurality of spatially diverse antennas are configured in a geometric array configured to provide isolation with respect to a direct path signal from reflections in environments with high metal content.

18. A method for compensating for Doppler shifts in phase-based ranging systems, said method comprising:
a) measuring relative motion between a transmitting and receiving device based on Doppler-induced frequency shifts in one or more RF signals received by the receiving device from the transmitting device;
b) dynamically adjusting phase measurements across multiple frequency channels to account for the Doppler-induced frequency shifts and to yield Doppler-compensated phase measurements; and
c) updating a phase-based range estimation by incorporating Doppler-compensated phase measurements to correct for motion-induced phase distortions caused by the relative motion between the transmitting device and the receiving device.

19. The method of claim 18, comprising updating the Doppler-compensated phase measurements based on real-time measurements of velocity and direction of the receiving device.

20. The method of claim 18, wherein said dynamically adjusting phase measurements includes incorporating amplitude and time-of-flight data to improve phase measurement accuracy.

21. The method of claim 18, wherein the phase measurements are further adjusted based on environmental factors including at least one of temperature and humidity that affect signal propagation.

22. The method of claim 18, further comprising predicting future Doppler shifts based on historical motion data to preemptively adjust the phase measurements and reduce latency in range estimation.

23. The method of claim 18, wherein said dynamically adjusting phase measurements includes adjusting the phase measurements separately for each frequency channel and then aggregating to provide a phase adjustment across the full bandwidth of the system.
